(19) United States
(12) Patent Application Publication
(10) Pub. No.: US 2023/0377268 A1
(43) Pub. Date: Nov. 23, 2023

(54) Method and apparatus for multiple dimension image creation

(71) Applicants: Kilton Patrick Hopkins, Berkeley, CA (US); Koii Benvenutto, Alameda, CA (US)

(72) Inventors: Kilton Patrick Hopkins, Berkeley, CA (US); Koii Benvenutto, Alameda, CA (US)

(21) Appl. No.: 18/136,033

(22) Filed: Apr. 18, 2023

Related U.S. Application Data
(60) Provisional application No. 63/332,274, filed on Apr. 19, 2022.

(51) Int. Cl. G06T 17/20; G06T 13/40

(52) U.S. Cl. CPC G06T 17/20; G06T 13/40

(57) ABSTRACT

A method of creating a modifiable digital representation. The method includes the steps of identifying at least one three-dimensional mesh and creating a metadata file comprising at least one separate object file. The at least one separate object file based in part on the at least one three-dimensional mesh. The method includes the steps of generating a pre-rendering version of the at least one three-dimensional mesh and preparing the pre-rendering version of the at least one three-dimensional mesh for rendering. A render of the pre-rendering version of the three-dimensional mesh is performed.

### PRIORITY CLAIM

This non-provisional patent application claims the benefit of U.S. Provisional Application No. 63/332,274 filed on Apr. 19, 2022, the entirety of which is incorporated herein by reference.

### FIELD

The present disclosure relates to systems and methods for image creation. More particularly, the present disclosure relates to systems and methods for multiple dimension image creation. For example, the systems and methods may be used for creating, editing, and rendering a multiple dimension image (such as an avatar) for a virtual world or virtual universe (metaverse). Such an avatar may comprise an electronic image that can be edited or otherwise manipulated by a user, such as by using a computing device like a handheld de-vice (e.g., a smartphone or tablet).

### BACKGROUND

Some current avatar creating technologies provide rudimentary building blocks for avatar creation, editing and animation. With most known avatars, there is limited functionality. Avatar creators are required to choose from predetermined body parts or preselected or predefined options and functions. For example, there may only be certain limited options for eyes to be selected, and only three options for the legs. Other avatar systems are related to ease of use systems that enable users to drag and drop certain features to create avatars, but these are still somewhat limited as to erecting certain creative barriers to the user.

In addition, typically when editing 3D objects such as avatars, an editing tool would normally add and remove vertices. Such an editing tool would then reconnect or reconfigure the planes and the polygons that fit into the vertices that are on the outer surface of this 3D object. And this is how 3D objects would be drawn, redrawn, and edited. These process steps are perceived as complex editing changes for the novice avatar creator or virtual world user.

In addition, for the 3D object industry standard OBJ file format, there is no unit of measurement. For this industry standard file format, all that is provided is a spatial relationship that is all relative points in space. In addition to not defining a unit of measure, there is also no notion of directionality in industry standard OBJ file types.

If a user is going to create a 3D model with certain available avatar creation tools and standard OBJ files, it takes a lot of skill, a lot of work, and potentially a lot of time. And so, this difficulty creates what may be perceived as a barrier of creation. People will therefore tend to prefer something that they can simply select, drag, and then drop into place. One challenge with this type of avatar builder is that the avatar creator will have limited choices and options. The resulting generated avatars will typically be somewhat generic having no individuality or possessing limited creative expression or uniqueness.

There is therefore a general need for systems and methods that allow a user more control over avatar creation, modification, and animation. These systems and methods should also enable enhanced user creative freedom, and simultaneously bring the emphasis onto the functionality of the created object, rather than minute details. The present disclosure represents methods and systems that are focused on creativity and social world building.

### SUMMARY

According to an exemplary arrangement, a method of creating a modifiable digital representation comprises the steps of identifying at least one three-dimensional mesh, creating a metadata file comprising at least one separate object file, the at least one separate object file based in part on the at least one three-dimensional mesh, generating a pre-rendering version of the at least one three-dimensional mesh, preparing the pre-rendering version of the at least one three-dimensional mesh for rendering, and performing a render of the pre-rendering version of the three-dimensional mesh.

According to an exemplary arrangement, the step of generating the pre-rendering version of the at least one three-dimensional mesh comprises the step of generating a blockified version of the at least one three-dimensional mesh. In one preferred arrangement, the step of generating the blockified version of the at least one three-dimensional mesh comprises generating a voxelized version of the at least one three-dimensional mesh.

According to an exemplary arrangement, the method further comprises the step of processing the pre-rendering version of at least one three-dimensional mesh so that the pre-rendering version is viewable on a computing device. In one arrangement, the computing device comprises a handheld computing device.

According to an exemplary arrangement, the method further comprises the step of selecting an image format for the at least one three-dimensional mesh. In one preferred arrangement, the image format for the three-dimensional mesh comprises an .OBJ format.

According to an exemplary arrangement, the method further comprising the step of performing complex three-dimensional object file edits.

According to an exemplary arrangement, the step of generating the pre-rendering version of the at least one three-dimensional mesh comprises the step of defining at least one pre-rendering parameter. According to an exemplary arrangement, the at least one pre-rendering parameter comprises an occupation parameter, wherein the occupation parameter is utilized to define a voxelized mesh.

According to an exemplary arrangement, the method further comprises the step of defining a set of parameters for the at least one separate object file. In one preferred arrangement, the set of parameters comprises at least one parameter selected from a group of transparency level, color, reflectivity, and texture.

According to an exemplary arrangement, the method may further comprise the step of defining a plurality of data keys for the at least one separate object file, wherein each of the plurality of data keys is representative of a predefined data type.

According to an exemplary arrangement, the step of creating a metadata file comprises the step of selecting a serialization language. For example, the serialization language is selected from a group consisting of XML, JSON, and YAML.

According to an exemplary arrangement, the step of creating the metadata file comprises the step of generating a plurality of descriptors.

According to an exemplary arrangement, the step of creating the metadata file comprises the step of defining at least one attach point for at least one sub-object residing in the metadata file, the attach point defining where the at least one sub-object may be attached to a second sub-object. In one preferred arrangement, the at least one attach point comprises a vertex comprising X, Y, and Z coordinates.

According to an exemplary arrangement, the step of creating the metadata file comprises the step of defining at least one interaction point comprising X, Y, and Z coordinates. In one preferred arrangement, the at least one interaction point is labeled for purposes of performing automated interactions or automated animations.

According to an exemplary arrangement, the modifiable digital representation comprises an avatar for use in a virtual universe.

A basis for the presently disclosed systems and methods relates to taking 3D models and processing these 3D models so that they are visually displayed as pixelated objects, representing certain identified detailed parts of an animatable object, like an avatar. Importantly, since the object remains as a 3D object, these objects can then be animated. For example, a rendering engine is disclosed that allows for a 3D representation of an object, wherein each frame where the object is being animated, twisted, or changed, the rendering engine performs a pre-rendering step. This is where the systems and methods translate the 3D mesh into a different 3D mesh that is voxel based.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a multiple dimension image processing system according to one arrangement;

FIG. 2 illustrates a multiple dimension image processing sub-system that may be used with an image processing system, such as the image processing system illustrated in FIG. 1;

FIG. 3 illustrates a method of creating a modifiable multiple dimension digital representation, according to one arrangement;

FIG. 4 illustrates a method of creating a metadata file for a method of creating a modifiable multiple dimension digital representation, such as the method illustrated in FIG. 3;

FIG. 5 illustrates a method of animating a modifiable multiple dimension digital representation, such as a modifiable digital representation that can be created by the methods illustrated in FIG. 3;

FIG. 6 illustrates an exemplary multiple dimension image for use with a method of creating a modifiable digital representation, such as the methods illustrated in FIG. 3;

FIG. 7 illustrates a composite image file that can be used with a method of creating a modifiable multiple dimension digital representation, such as the method illustrated in FIG. 3;

FIG. 8 illustrates a voxelized image file of a composite image file, such as the composite image file illustrated in FIG. 7;

FIG. 9 illustrates a modifiable digital representation for use in a multi-dimensional world, such as a modifiable digital representation that can be created by the method illustrated in FIG. 3;

FIGS. 10 a,b,c illustrate an exemplary master data file that may be used with a method of creating a modifiable multiple dimension digital representation, such as the methods illustrated in FIG. 3;

FIG. 11 illustrates an exemplary animation of two modifiable multiple dimension digital representations, such digital representations can be generated by the methods illustrated in FIG. 3;

FIGS. 12 a,b,c illustrate an exemplary process for editing a voxelized 3D mesh such as removing individual voxels;

FIGS. 13 a,b,c illustrate an exemplary process for editing a voxelized 3D mesh such as adding individual voxels;

FIGS. 14 a,b,c illustrate a system and methods for symmetrically editing a 3D voxelized object;

FIGS. 15 a,b,c illustrate a system and methods for non-symmetrically editing a 3D voxelized object; and

FIGS. 16 a,b,c illustrate an exemplary process for editing a voxelized 3D mesh such as coloring individual voxels.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Therefore, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The present disclosure is generally related to systems and methods for creating a multiple dimensional animatable model. In one preferred arrangement, the multiple dimensional image is built in 3D, with a plurality of 3D shapes. These 3D shapes are then rendered down into a final 2D render. Users and creators can see this final 2D render and can then modify or revise this final 2D model. The final image is built up of kind of like an onion with a 3D object that then gets turned into a blockized or voxelized form. This form is less complex for the user to change and iterate and experiment with. Finally, the blockized or voxelized form then gets represented for a virtual universe or the metaverse, as a lower dimensional rendering, such as 2D or 2.5D rendering.

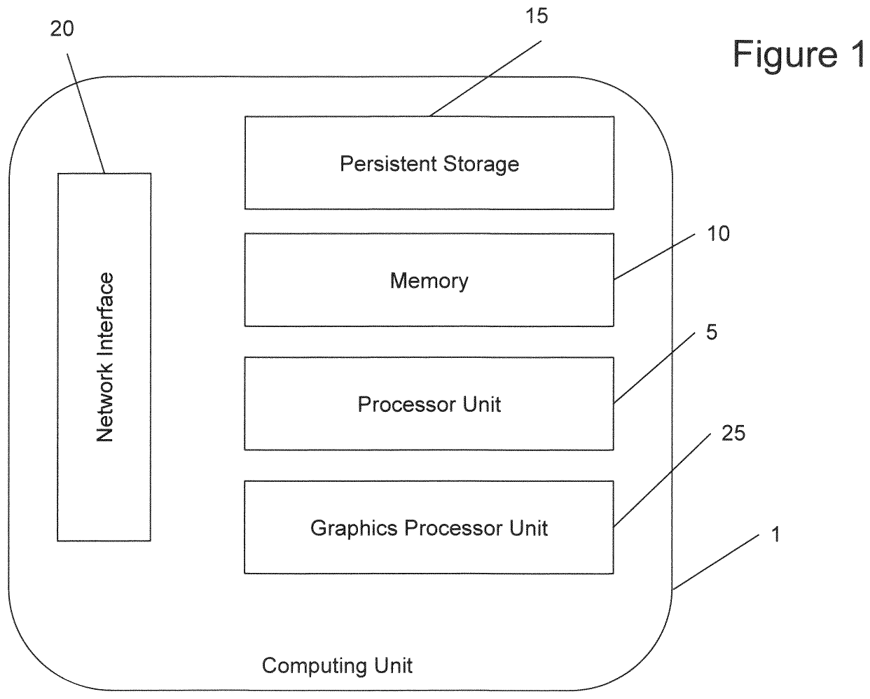

FIG. 1 illustrates a multiple dimension image processing system according to one arrangement. More specifically, FIG. 1 illustrates an exemplary compute machine 1 on which the disclosed rendering engine technology is able to operate, able to run. The presently disclosed rendering engine and related technology can run on any compute machine 1 that is made of standard components. In other words, that means that the disclosed rendering engine and related technology operates independent of computing architecture, so it could be any variety of computing processor types.

As just one example, the computing unit 1 may comprise a processor unit 5 and this processor unit 5 may comprise a micro controller in which the code is written to do the computation. As an example, the processor unit 5 might comprise an 8-bit or 16-bit or 32-bit micro controller of the type that you would find embedded in certain wearable devices. In one exemplary arrangement, this processor unit 5 may comprise an 8-bit micro controller made by Atmel Technologies or a 32-bit micro controller made by STMicro. These devices have certain advantages as they are generally of high production volume and are economical micro controllers.

In one arrangement, the processor unit 5 may be of a standard desktop or laptop computer type or smartphone type such as a multi-core arm based processor of the type that's used in certain known devices, such as the Apple iPhone, or the Samsung Galaxy phones. In arrangements, the processor may comprise an X-86 architecture processor of the type made by Intel, similar in certain respects to a Windows or a MacOS desktop or laptop compute unit using a standard Intel processor. All of these are suitable in arrangements. And so that is what is meant by independent. The presently disclosed rendering engine and related systems and methods run independent of certain conventional computing architecture.

As illustrated, the compute unit 1 further comprises memory 10 and persistent storage 15. The other standard components aside from the processor unit are memory and persistent storage. These are the only other units that are components that are required for the computing unit 1. One reason for this is that is because the processor unit 5 should have working memory and have persistent storage 15 in order to store the software program of the disclosed rendering engine and related systems along with perhaps an operating system or a BIOS or an interpretation engine. This could also include software that might be required in order to run the processor and then execute the rendering engine that is an implementation of the rendering systems and methods as disclosed herein.

In one arrangement, memory 10 can be a form of working memory, typically in persistent storage, such as RAM, as you would typically find in a desktop or laptop computer. This is a common computing component such that you can independently acquire a source of RAM and couple it to the processor unit 5. One example would be your DDR3 random access memory chip sets that are available as plug-in modules for a desktop computer. Similar memory components would also be suitable in arrangements. That is the working memory, the volatile memory that is used by the processor to performs computations.

And the other common component is persistent storage 15. In arrangements, this persistent storage 15 may comprise flash memory or a solid-state disc drive. Alternatively, or in addition, this persistent storage 15 may comprise a magnetic disc drive, or a type of storage form that would allow for the long term or persistent keeping of the software code as well as any resulting computation, the desire to be kept or anything similar. In other words, compute files and binaries that are the executable code.

Optionally, the compute device 1 may comprise a networked compute device. And so in one arrangement and as illustrated in FIG. 1, a computing unit 1 is illustrated that is simple in that it contains the three components previously mentioned processor unit, memory, and persistent storage, but also may contain, be comprised of a network interface 20. In addition, the compute device 1 may also comprise a graphics processor unit or GPU 25.

In one exemplary arrangement, the network interface 20 would enable the compute unit 1 to be interconnected with other network or compute systems or network structures. This is not a requirement for the presently disclosed rendering systems and methods, but may prove advantageous because the compute unit would then be able to distribute the calculated rendering engine results over the network.

And this would also allow the compute unit to receive inbound network traffic for receiving requests to do computation and use the disclosed rendering technology to do the computation or could receive 3-D object files that would be used in the disclosed rendering technologies. In arrangements, these are possibilities that come from the computing unit 1 comprise a network interface. And so, with the computing unit 1 that comprises a network interface 20, the computing unit 1 could properly operate as a server or a network-attached compute unit 1 or network-attached compute node. These are all possibilities in a disclosed arrangement.

In one preferred arrangement, the computing unit 1 could comprise a wearable computing device that is connected where the network interface is one form of wireless or another form, one or more forms of wireless, such as Bluetooth, Bluetooth low energy, or Wi-Fi, any of these types of computing interfaces are suitable here. As another example, the network interface could be configured to utilize either cellular or cellular wireless technologies in arrangements.

And in one arrangement, the compute unit 1 may also contain a graphics processor unit or a GPU 25. The graphics processor unit 25 could optionally be used to accelerate the speed of computation for the disclosed rendering technology meaning that the rendering technology could be implemented in such a way that parallel processing of the type that you would find in a graphics processing unit could be utilized. This would allow the compute unit to therefore execute multiple steps of computation simultaneously, bringing the results back together, such that a faster performance could be delivered from that implementation. A GPU 25 is not a necessity of the presently disclosed systems and methods, but maybe an advantageous implementation.

The graphics processor units 25 are typically found in consumer computing devices such as smartphones and can be an essential part of high-performance computing machines such as gaming laptops and desktops. But they are also found in network-attached devices, such as servers because of the parallel processing capabilities that the graphics processing units add to the standard compute capabilities. So that describes an exemplary type of compute unit 1, flexible hardware on which the disclosed rendering engine and related technology can be processed and executed.

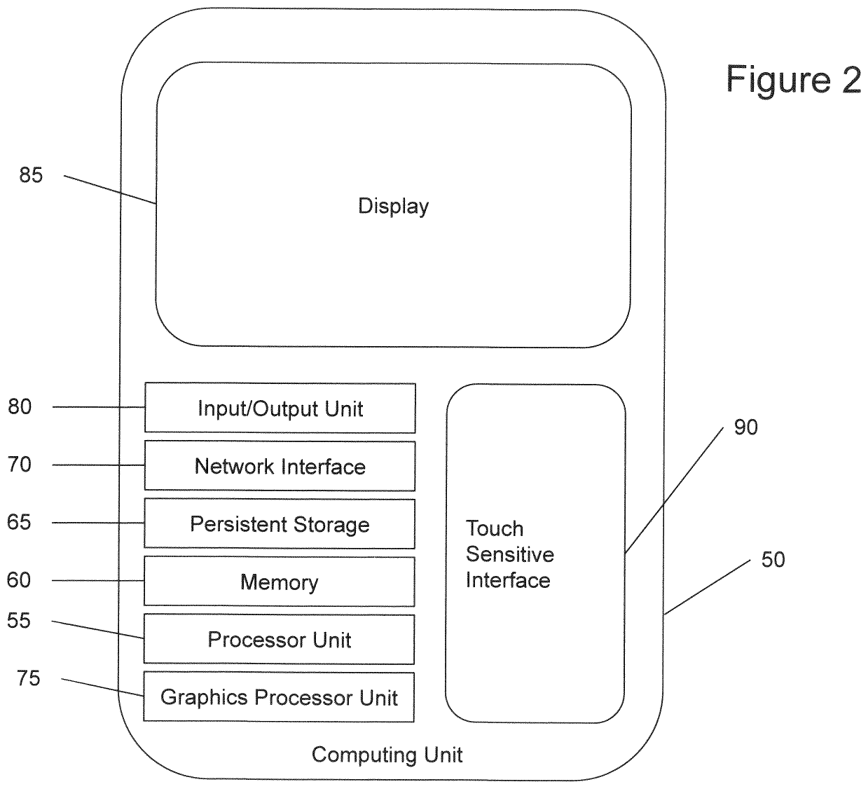

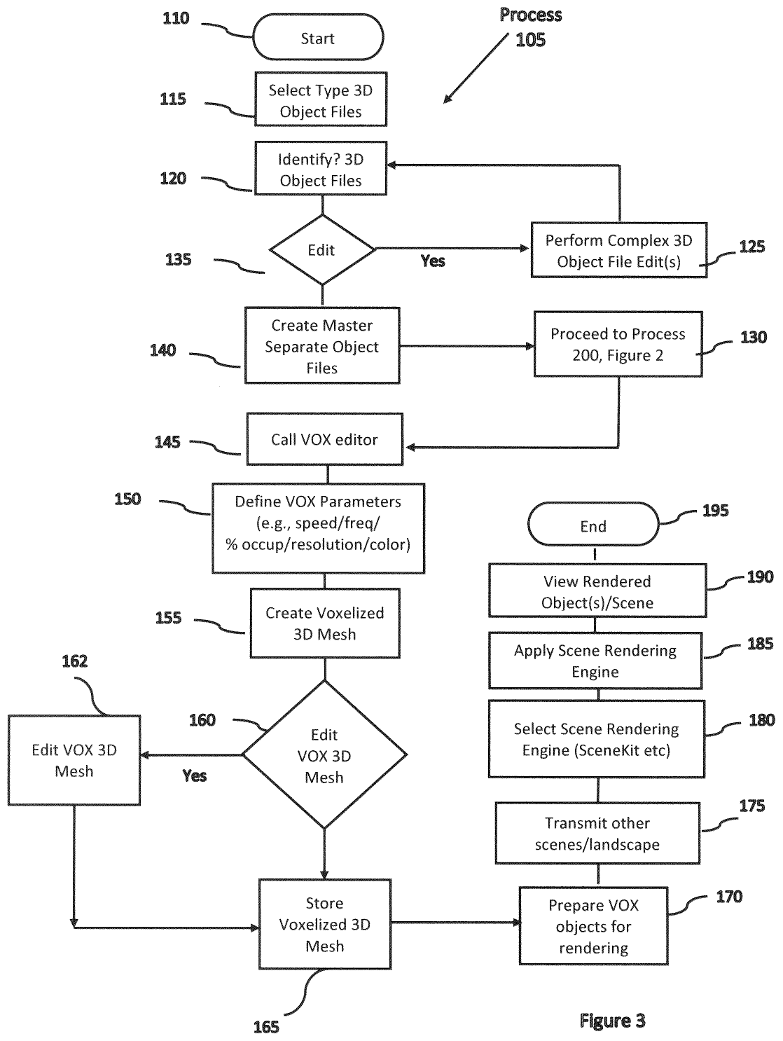

FIG. 2 illustrates a multiple dimension image processing sub-system 50 that may be used with an image processing system, such as the image processing system or compute unit 1 illustrated in FIG. 1.

The multiple dimension image processing sub-system 50 or compute unit 50 illustrates another suitable machine on which to run the disclosed rendering technology. FIG. 2 illustrates a compute unit 50 that is an exemplary illustration of a handheld, personal compute unit 50. In one preferred arrangement, this personal compute unit 50 is similar to a smartphone or a personal digital assistant or similar type of device. Such a unit 50 may provide a display 85, an integrated display and integrated form of input, such as by way of an Input/Output Unit 80.

The compute unit 50 illustrated in FIG. 2 comprises several similar components as illustrated in the compute unit of FIG. 1. That is, the compute unit 50 of FIG. 2 comprises a processor unit 55, memory 60, persistent storage 65, a network interface 70, and graphics processor unit 75. In one preferred arrangement, the network interface 70 and graphics processor unit 75 are optional unit components. However, as noted, one or more of these components can be advantageous to include in the personal computing unit or computing unit 50 that is fully integrated because of the additional capabilities that such a device provides, although they are not required.

This compute unit 50, illustrated in FIG. 2, may also contain at least one Input/Output Unit 80. This component 80 is capable of receiving one or more inputs through a variety of input interfaces and also provides one or more outputs which can be provided to a number of different display interfaces. The unit 50 illustrated in FIG. 2 also comprises a touch sensitive interface 90 which is a computing interface for allowing a user to touch the screen or a touch pad. This screen or touch sensitive interface 90 is also software enabled so as to track the movements or the gestures of a user's finger or fingers. These movements can then be processed as an input, which can be processed through the Input/Output Unit 80, to inform the computing and direct its flow. In other words, the ability to move an object (such as a 3D object or a portion of such an object) around the display or screen 85 by dragging one's finger.

Alternatively, the touch sensitive interface 90 could also be replaced or could be supplemented by other types of human interface components. As just one example, a touch sensitive interface could be replaced or supplemented with a computing mouse or a joystick or another form of operable input devices that would allow a user of the computing unit 50 to provide that type of information to the computing unit in order to direct the results of the disclosed rendering technology.

Also included in this computing unit 50 in FIG. 2 is a display 85. In this exemplary computing unit arrangement, the display 85 is illustrated as residing within the computing unit 50. However, as those of ordinary skill in the art will recognize, the display 85 does not need be contained within computing unit 50 itself. Rather, any display can be wirelessly tethered or hardwired to the computing unit, whether the display is a large screen television or a projector or an integrated touch screen display, such similar displays are suitable for this computing unit 50.

The intention of illustrating the display 85 as shown, even though it is optional, is to illustrate that an integrated display or an attached display would allow the user of the disclosed rendering technology to see rendered results which would give a visual feedback to the user. In one arrangement, this would allow the user to use the disclosed rendering technology to amend or revise the 3D object in real time, quickly and efficiently by way of the display 85 and/or the touch sensitive interface 90 of the computing unit 50.

In an alternative arrangement, additional components could include interfaces provided by computing units such as audio input, output, haptic or vibrational feedback, and other similar types of input and/or output signals. Even though not illustrated, compute arrangements that are commonly used to execute software and provides computing applications to users may also be suitable for operating the disclosed rendering technology. As noted, the disclosed rendering technology can be implemented in software code similar to other software technology in that it can be written in a language with standard capabilities and compiled for certain known processors like other pieces of software that would follow the standard implementation.

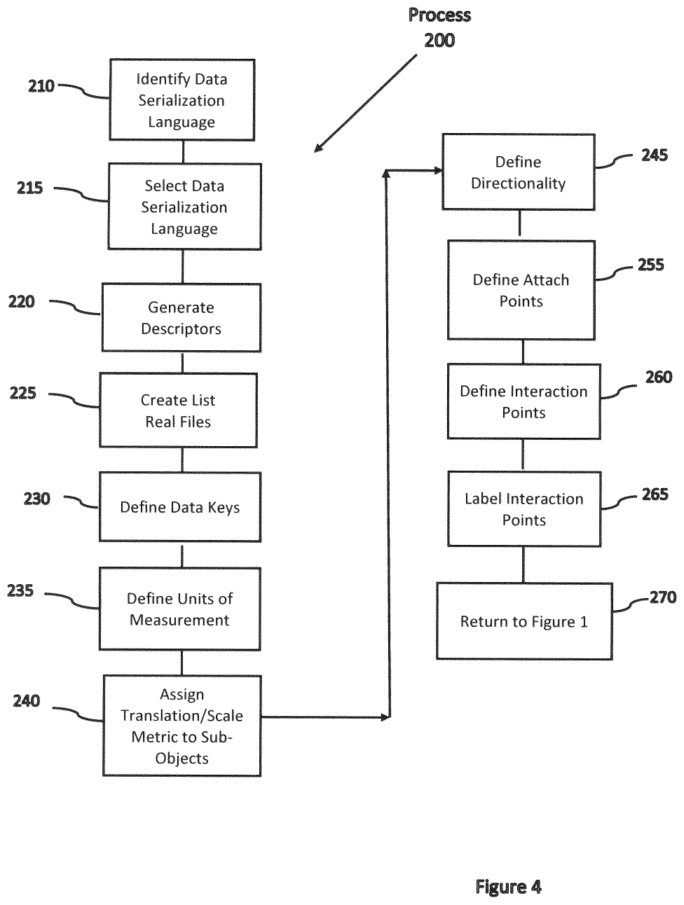

FIG. 3 illustrates an exemplary method 105 for creating such a multiple dimensional animatable model. As will be explained in greater detail herein, the method 105 initiates at step 110 and proceeds to step 110 where a preferred form for the object files is selected or determine. This form may comprise certain known or industry adopted object files like, for example, OBJ files. The method proceeds to step 115 where the rendering engine identifies the 3D object files.

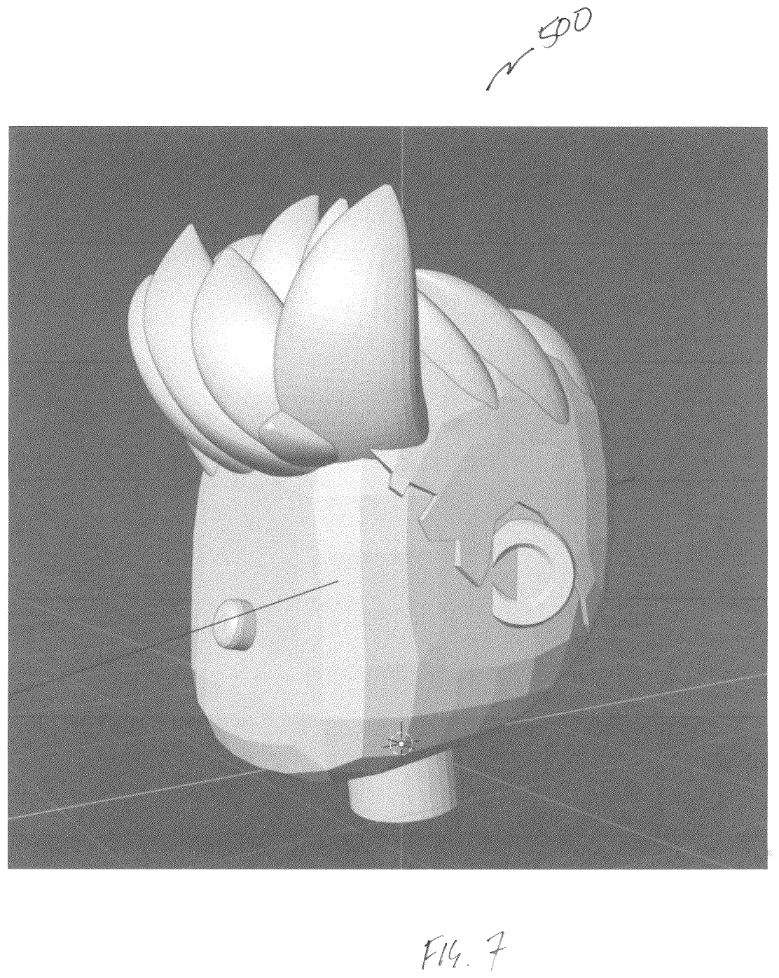

Next, the process proceeds to step 120 where the rendering engine, or in some preferred arrangements a user of the rendering engine, determines that an object represented as a multiple dimension image needs or require edits. For example, FIG. 6 illustrates an exemplary 3D mesh representation 400 wherein this mesh comprises a plurality of vertices, edges and faces that define the shape of a 3D object. In this illustrated arrangement, this 3D object may comprise the head of an avatar. The exemplary multiple dimension image 400 comprises an image for use with a method of creating a modifiable digital representation, such as the method 105 illustrated in FIG. 3.

If the decision to create edits to the 3D object is determined to be made at step 135, the method 105 proceeds to process step 125 where the complex 3D object file edits are performed and thereafter the method returns to step 115 in process 105.

Next, the process proceeds back to the editing step 135 to determine if any further 3D object file edits are required. If no further edits are required, the rendering process proceeds to step 14 in process 105 where the rendering engine initiates the creation of a master separate object file or a metadata file. This master separate object file will represent a composite image comprising one or more sub-object files.

To initiate this master separate object file, the rendering engine proceeds to step 130, which comprises a step for generating a separate master object file. In one preferred arrangement, this step comprises a method, such as the process 200 illustrated in FIG. 3 and as further described in detail herein. Process 200 will generate a separate master object file also referred to as a metadata file that will represent a composite image.

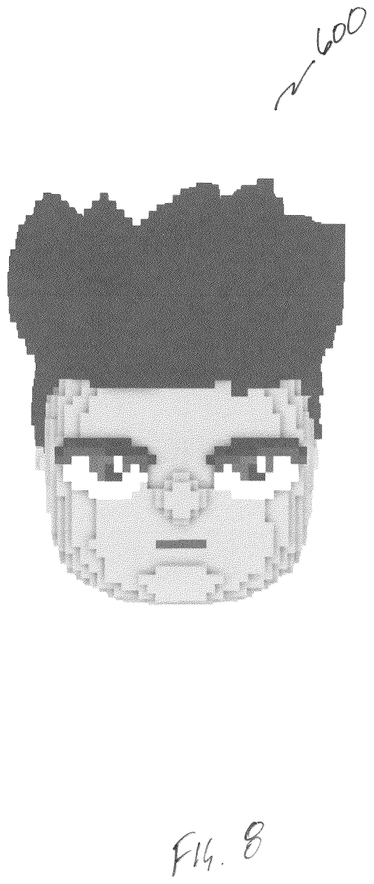

This is how avatars can be created with the systems and methods disclosed herein. For example, as illustrated in FIG. 7, a head of an avatar is illustrated. As just one example, such a head of an avatar may be displayed to a compute unit while a user is reviewing and editing the avatar. For example, this head may be shown on the display 85 of the compute unit 50 illustrated in FIG. 2. With this displayed object, a user may utilize the touch sensitive interface 90 to amend or revise the object as discussed in detail herein.

And this head is represented by a metadata file or a master file comprising a plurality of sub-object files. And these sub-object files may comprise a file for the separate objects like the avatar's nose, for each of the two ears, the hair, the ears, and the neck of the avatar's head. Each of these sub-object files comprise separate 3D mesh objects. With the presently disclosed systems and methods, these separate 3D mesh objects can be swapped or inserted into and out by the user. In addition, these separate object files can be edited by somebody who is more skilled or proficient with editing. These objects can then be placed back into the presently disclosed systems and methods in later iterations.

For example, FIG. 7 illustrates a composite image 500 that is generated by the process 200 illustrated in FIG. 3.

Returning to FIG. 3, after the master separate object file is created at step 130 (i.e., the process 200 illustrated in FIG. 4), the method 105 proceeds to step 145 where the rendering engine calls a voxel editor. In one preferred arrangement, the rendering engine comprises this voxel editor. In an alternative arrangement, this voxel editor comprises a separate engine, one that resides separate and apart from the preferred rendering engine.

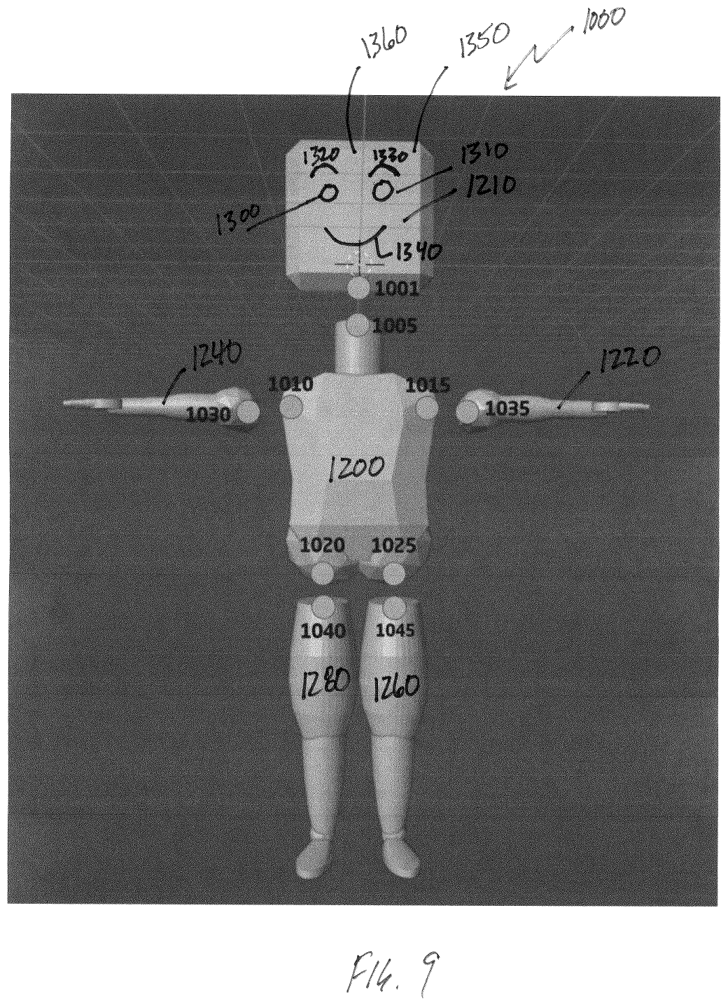

After calling the voxel editor at step 145, the process 105 will proceed to step 150 where the rendering engine will call certain predefined voxelization parameters. In on preferred arrangement, these parameters may be changed or modified by a user of the disclosed rendering engine. These parameters will be used to create or structure the voxelized 3D mesh. As will be described in greater detail herein, these voxelization parameters may comprise speed, frequency, percent voxel occupancy, resolution and/or color. After step 150, the method proceeds to step 155 where a voxelized mesh or 3D object is created. For example, FIG. 8 illustrates a voxelized mesh or 3D object 600 that may be created during the processing step 150.

After a voxelized mesh is created at step 155, the rendering process proceeds to step 160 where the method decides whether the voxelized 3D object created at step 155 will be edited. If the user decides to edit the voxelized 3D mesh at step 160, the method proceeds to step 160 where the rendering engine decides to edit the voxelized 3D mesh. After the voxelized 3D mesh is edited at step 160, the process proceeds to step 165 where the voxelized 3D model is stored in memory. After the voxelized 3D mesh is stored, the method proceeds to step 170 where the voxelized objects are prepared for rendering.

Once the voxelized objects are prepared for rendering at step 170, the process 105 proceeds to step 175 where other scenes or landscapes are transmitted. Next, the process proceeds to step 180 where the process 105 selects a scene rendering engine, such as the SceneKit rendering engine offered by Apple, Inc. of Cupertino, California. Once the scene rendering engine is selected at step 180, the process proceeds to step 185 where the process applies the scene rendering engine to the objects, the scene, and/or landscapes that were previously identified or selected at step 180. Then, the process proceeds to step 190 where the rendered objects, scene and/or landscapes are viewed by a user on a display device, such as a handheld computer or compute unit as illustrated in FIGS. 1 and 2.

The presently disclosed rendering engine outputs a revised or re-rendered 3D object. This may be accomplished at a high frame rate, in real time. As such, the original object remains the same, but as it would change its shape during an animation of like a bouncing ball, as every frame of it changing its shape, the rendering engine voxelized the shape, or it blockifies the shape. The engine then creates an output that is then a voxel 3D model, but the voxels are defined in real time. The presently disclosed systems and methods can adjust the resolution since the underlying sphere does not change.

Therefore, as an example, the system then creates a blocky sphere in the form of 20 voxels by 20 voxels. The user would then like to revise or edit this blockified form by removing one of the voxels from the outer edge. This would occur at process step 162 in FIG. 3.

And from a user's perspective, the user will think the blockified object presents a flat square, not a cube. The user would select or click certain voxels to delete these voxels. The presently disclosed systems and methods then take that information and pass it backwards through the rendering engine. So instead of rendering it from the sphere to the overall object, the rendering engine eliminates this cube of space that used to have at least a certain predefined volume in it, for example, 50% volume. In a preferred arrangement, this volume consideration is a scalable component.

Now we know that to attach the other two and remove that, what we really want to do is we want to put the vertex of the mesh right at the edge where the cube used to be.

So that way the system would trigger a cube to be present, when the system slices up the space, but the 3D model remains in intact. Meaning that the system heals the object from the removal of that cube. And then if one were to look at the 3D model, a user would see that the voxel was removed, but the 3D model, if viewed in pure 3D form remains as its original object with a little curvy chunk removed from of its contour. In this manner, the rendering engine altered the location of the vertex that we used to think was 50% or more of a space. So one could have very fine detail and then a portion is removed and then replaced, and then later it has been smoothed over.

With the presently disclosed systems and methods, a 3D mesh remains behind the 2D representation or the 2D looking representation. If a user wants to alter this representation by changing out an object like the arm on an avatar using the presently disclosed rendering engine, this can be achieved. With the presently disclosed systems and methods, a user can edit the arm sub-object and no other sub-object of the main object. For example, a user may use a rendering engine editing tool to select or just click one or more pixels until the user is satisfied with the resulting edited image generated by the rendering engine.

If the user were to run an animation where this revised avatar raises its edited arm or hand, and it used to be smooth with the original arm, how does the disclosed system and methods illustrate this revised avatar object. To animate this revised object, the system has traded out the mesh points for that arm, by allowing the user to select or click the pixels and edit. The system animates this revised arm the same way using the same formula, because systems and methods utilize interaction points as will be described in greater detail herein.

In most conventional image processing systems, if a 3D object is defined, a standard file type would be used. And the most popular object file is the .OBJ object file, which is the object file format as created by Wavefront Technologies. These object files comprise a list of vertices in a mesh, and then faces of polygons that use those vertices.

An OBJ file is a standard 3D image format that can be exported and opened by various 3D image editing programs. It contains a three-dimensional object, which includes 3D coordinates, texture maps, polygonal faces, and other object information. OBJ files may also store references to one or more material files (.MTL files) that contain surface shading material for the object. The selected object file defines materials from which everything is composed, and material specify, color, transparency, shininess, texture, and related information.

Theses ordinary .OBJ file types do not allow one to mix together different types of objects, unless one does a lot of work to make certain groupings. The present system and methods define one or more separate objects, such as the eyes as a separate object. The present system and methods also include some information about where each of the separate files need to engage one another or meet up, if that is what is required. And that way, users are free to change the eyes or import a plurality of different eye files from a separate or remote source file, like the Internet. A user could then have a large number of different eyes to choose from.

And importantly, as these separate object files are created by the systems and methods disclosed herein, these separate object files are also editable. The combination of multiple mesh objects by a master data file that then designates each separate sub-object. The master data file also describes the associated look and feel materials of each of the separate object files and also describes how these objects can be connected or linked up with one another as well. In one preferred arrangement, this information is contained in one master data file or meta data file as generated by process 200 illustrated in FIG. 4. In one preferred arrangement, the presently disclosed metadata file is added on top of the existing 3D technologies. As illustrated in FIG. 4 and as described in detail herein, this master data file comprises information that can be exported from various different types of systems.

As such, the presently disclosed systems and methods allow users to edit only one or two sub objects of an avatar without modifying the avatar as a whole. For example, the presently disclosed rendering engine is advantageous if for example a user just wanted to edit the bow and hairband on an avatar's head since these two objects would comprise separate object files residing in a master data file. And this editing could take place without negatively impacting any of the other portions of the object that the user does not want to change or modify. That is, one could edit the bow or headband on an avatar's head but need not have to edit the hair object file or the eye object file. Therefore, this preferred arrangement utilizes a metadata file format generated by the process 200 illustrated in FIG. 4 that combines existing but modified file format technology. And it combines and then supplements this file format technology in a way that allows the presently disclosed rendering engine and related systems to extract additional information from of theses ordinary types of file formats.

In the world of 3D objects, there are numerous file formats, some of which have become more dominant than others in the industry. A preferred standard for the systems and methods disclosed herein is the standard called the .OBJ or the Wavefront Technologies object file. This object file format is a preferred format for certain applications as it represents a human readable format, meaning that it is structured as a plain text format. In addition, this object file format consists of identifying or listing out vertices. And the vertices have three coordinates attached to each of them, which is the X, Y, and Z coordinates. After the number of vertices is listed, all of the vertices, one can then proceed to list the faces of the polygon mesh that use those vertices represented, thereby defining the metes and bounds of the three-dimensional object.

Each OBJ file comprises a polygon mesh, or a list of vertices and faces. This list of vertices and faces make up an object, such as the object 400 illustrated in FIG. 6. This OBJ file can also include data that defines the materials for each of those vertices and faces. This information can be sufficient for creating or rendering certain static objects. However, a potential challenge is that, if a user is going to make edits or modifications to any of these objects that are an OBJ file format, a complex 3D mesh editor will be required. Such a 3D mesh editor may be something like an open source tool like Blender, or some other industry standard tool.

For certain novice mesh editor users, this may be a complex process because, in a situation where a particular user would like to edit or amend an OBJ file, such users may be editing the vertices and the polygon faces that make up the object. This editing process can get difficult for novice users to be able to make desired changes and modifications without negatively affecting the 3D object as a whole. In addition to potential editing difficulties, if there is an OBJ file that comprises the entire object in its complete form, the user will also face other challenges because there will be limited abilities to separate certain of the object's sub-components from one another of a complex form.

The systems and methods of the present disclosure are utilized for the creative creation of a digital representation of objects and things. The disclosed rendering engine and related systems are particularly useful in the creation, editing, and animation of three-dimensional personal representations such as avatars, a human-like character for use in the metaverse or an online virtual world.

In certain arrangements, some users may prefer to be able to animate the movement of a sub-component from other related or unrelated sub-components. Such as, for example, animating the movement of an avatar's mouth and the eyes separate from the underlying mesh that defines the head shape, body shape, or some other tangible or intangible object. And this is because the user may not want to have to animate the change in all of the vertices and the faces, polygon faces, if the user could just animate the movement of the eyes or mouth themselves.

But a challenge here is that it is difficult to define and clearly separate the sub-components of the primary objects using the standard OBJ file format. In certain configurations, different OBJ file format sections can be labeled. That is, one can label the different polygon faces. However, the OBJ file format does not allow the labeling of vertices. And this can make for a complex file format wherein one would need to know ahead of time what each of the labeled vertices mean and how they would need to be interpreted. This is not sufficient to use the standard OBJ file format for making composite objects. Therefore, what is generally needed is a system and method that utilizes a rendering engine to assimilate multiple standard files, such as OBJ files, into one master composite object file or metadata file.

In one preferred method and system, a master or metadata file is created in the same location or in a different directory near the OBJ files. This metadata file references the OBJ files as being components of a composite object. Referring to FIG. 3, the generation of such a master data file is represented by the process step 130 which is further represented by the process 300 illustrated in FIG. 4 and described in detail herein.

The underlying format of the composite file can be an acceptable data format such as XML, JSON, or YAML. These are all formats that are industry standards in computing, and any one of them is suitable as being the underlying basis for the presently disclosed systems and methods. However, various different composite formats may require a different or a separate file parser, data parser, in order to use the different formats.

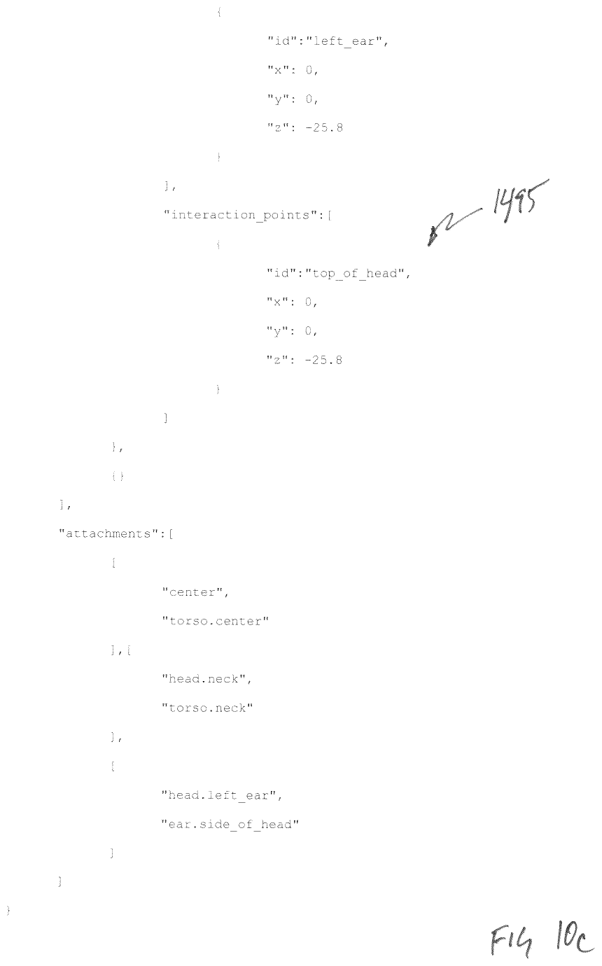

In one preferred arrangement, the format comprises the JSON format. For example, FIGS. 10 a,b,c illustrate an exemplary composite file 1400 wherein this exemplary composite file is in the JSON format. As those of ordinary skill in the art will recognize, alternative exemplary composite files having other types of file formats may also be utilized.

JSON type formatted data can be efficiently passed between computing systems, and it also transmits effectively over the wire in plain text. In one arrangement, the present systems and methods utilize a JSON file and as illustrated in FIG. 10a, the JSON file may comprise a certain title, like the title avatar.json. And this file will be provided with a definition at the very top, which includes text information that is useful for the system. In one arrangement, a unique identifier 1410 of an avatar will be provided, which might comprise some type of UUID information (Universally Unique Identifier). This information can be used to identify this avatar in an metaverse system, irrespective as to who created the avatar.

And then what follows is perhaps a human readable name (“Sophie”) 1420 for the avatar. This could be a username that someone prefers to have their avatar called when it appears in a metaverse system. Following that, and this is acceptable to put at any point in the file but following that or somewhere in the file would be a list of real OBJ files 1460. Following this list of real OBJ files, the names of the various Sophie avatar parts that the identified OBJ files represent could also be provided. For example, the Sophie avatar part “head” 1470 and its corresponding file information is illustrated under the heading “object” 1475.

Within this standard format, OBJ would be for a general object and MAT would be the code for a material and CLO might stand for article of clothing. And then AVA would stand for avatar. The JSON code illustrated in FIG. 10a would then represent the master dimensions 1425 for the whole avatar “SOPHIE”, so this would include that avatar's length, width, and depth. In addition, the master data file could also include a set of minimums, maximums, and center in the coordinate spaces.

The system and method further can define a standard enumeration of sub-component parts (e.g., avatar body parts) as data keys. Such data keys might comprise left eye, right eye, nose, left ear, right ear, mouth, hair, head, or neck. In an example where these data keys are published as an industry standard, users will recognize that when those data keys appear in a metadata file, they are an instance of a predefined type of data. For example, users will recognize that if the data key entitled “left eye” were included in the master data file illustrated in FIGS. 10 a,b,c, it would correspond to a certain predefined type of data, such as the left eye of the avatar “Sophie.”

Perhaps in one arrangement, these plurality of data keys can be expanded to comprise an extensible system wherein a particular component grouping is represented, such as the eyes of an avatar. And eyes may be followed by any number of eyes, wherein the systems and methods would allow a user to generate an eight-eyed, arachnid creature as an avatar in the metaverse, as just one example. So, given this optionality, the present systems and methods have the flexibility to define these types of possibilities for defining various types of these composite objects. And the rest of it would be up to the creator in order to place the composite objects onto the final complete object.

For example, in one arrangement, the metadata file may include a group section called eyes. And underneath this group section called “eyes”, the system includes an array of objects or a further dictionary of objects. And these are terms that correspond to the JSON data format. An array would be represented by a listing of unlabeled items and a dictionary would be represented as a listing of labeled items. And so underneath the group section called “eyes”, the following items may be provided: “left eye”, “right eye”. And each of these items would then be followed by the OBJ file that corresponds to the left eye and the right eye, respectively. So, using this exemplary structure of a metadata file, the system and methods would include two OBJ files in a composite avatar. However, as those of ordinary skill in the art will recognize, alternative group sections and group section orientations may also be utilized.

One advantage of utilizing such a file format and having such a data format allows the system and methods to parse those OBJ files as this underlying data exists in an industry standard format that can be readily extracted and then further enhanced from a functional standpoint. And this data file format allows these OBJ files to be used to generate a composite object for a virtual world or virtual universe, such as an avatar. A user could then work on either of those OBJ files for purposes of preparing an animation or additional editing or revising. Importantly, one would accomplish either the animation or the editing without disturbing the remainder of the OBJ files residing within the composite object master file. Therefore, with the presently disclosed systems and methods, a user would possess a certain degree of creative freedom and flexibility with utilizing such a composite object file format structure.

Similarly, the same thing would hold for building out the rest of the composite object's body. The presently disclosed rendering engine creates the ability to segment this process. For example, an avatar creator could edit or revise the torso, waist, left leg, right leg, knee, shin, or calf, whatever the system or method decides to call the lower portion of the leg. The system or methods may be utilized to describe each and every external body part of a human being. This allows for avatar creation that is fully segmented, thereby enhancing a user's creativity and expression.

Because each OBJ file that makes up the composite object is a complete and independent OBJ standard file, each of these complete and independent OBJ files is also free to be defined and created by a 3D editing tool. These independent OBJ files may be stored on disk in a structure such that the presently disclosed systems and methods are only required to swap out or exchange the one OBJ file that has changed. The remaining object files residing in the master data file do not need to be revised or altered. For example, if during avatar creation or editing or enhancement, a user has changed the left pinky finger knuckle of an avatar, that is the only OBJ file that needs to be modified since each OBJ file resides within the master data file as an independent, stand-alone file.

When that particular object file has changed, the disclosed rendering engine only needs to update that text file, that OBJ text file over the network. As a consequence, with particular avatar changes, when they are edited, these changes are structurally compact and are therefore transmissible in an efficient and effective form. This can be beneficial for interconnected metaverse systems. For example, such systems will therefore comprise a lower data rate, a lower error rate, less complexity, and allow for faster updates.

One advantage of the presently disclosed systems and methods is that each of these OBJ files is able to define its look and feel independently from one another. That means that, in one preferred arrangement, levels of transparency, color, reflectivity, all of these textures, all of these things can be defined independently for each of the object's sub-components. Again, this enhances a user's creative expression by making it less complicated for a user to work on an avatar's hair which will be defined as an independent and separate sub object file from the head to which the hair is virtually attached. This hair OBJ file can therefore be edited and manipulated so that the user can get the hair to look and to feel just right. Single file changes and manipulations is less complicated for a user when the user is not required to make similar types of changes to a master object file in which multiple sub-objects are interconnected virtually.

As discussed, the presently disclosed rendering engine generates a master file or a metadata file for each composite object. Then, the system and methods create a list of one or more sub-objects. These sub-objects are part of the composite object and labels them.

The OBJ industry standard file format for each sub-component (e.g., the left eye) is provided. Now these sub-components need to be brought into the composite object. In order to reference a particular sub-component into the master object (e.g., the avatar), the systems and methods will need to define a unit of measurement. And, in one preferred arrangement, this unit of measurement will define a preferred unit of measurement for all of the X, Y, Z coordinate points in the industry standard OBJ file format. In FIG. 10b, an exemplary unit of measure 1480 for the sub-component head is illustrated.

For the industry standard OBJ file format, there is no unit of measurement. For this industry standard file format, all that is provided is a spatial relationship that is all relative points in space. Therefore, reading these files is all subject to interpretation. What the coordinate one, 1.57 in terms of X, Y, and Z, what that relates to, versus the 0-0-0 origin point is not further explained. In other words, with such provided coordinates, one cannot determine where an object's center resides or where spatially the first sub-component (“head”) resides with respect to a second, different sub-component.

For example, such units of measure could be 10 meters, it could be 1000 feet, and it could be one millimeter, as the unit of measure. And it's open to interpretation in every system, whether it be English or Imperial or metric units of measurement. Therefore, for image or avatar creation, this presents certain challenges.

In terms of the presently disclosed sub-objects or sub-components (e.g., a left eye sub-object), the presently disclosed composite object, that OBJ file, for example, let us say that it is one unit in either direction in terms of X. There is the zero center and there are two vertices, the first being negative 1, and second being positive of 1, making the object having a width of two. And for the sake of this example, assume that the object has a Z depth of 1. Therefore, it is 0.5 in either direction and then a Y height of 1. So, 0.5 in either direction. Assume also, that there is a right eye sub-object that has a similar dimensionality, but a different unit of measure.

So let us say that is negative 10 plus 10, and then negative five plus five, this will have the same shape, but at a different scale. In the metadata file of the presently disclosed systems and methods, a unit of measure will be defined. This is illustrated as method step 235 in FIG. 4. In a subsequent step illustrated as method step 240, this unit of measure is then assigned a translation or a scale metric. In one preferred arrangement, this unit of measure is assigned to all of the sub-objects within the metadata master file. However, as those of ordinary skill in the art will recognize, alternative assignment and translation methods may also be used. For example, in one alternative arrangement, perhaps the unit of measure is assigned to only a subset of the sub-objects based on a certain parameter (e.g., color, weight, material, texture, etc.).

So, if our composite object is doing, unit of measure is one meter, where one equals one meter, which uses that measurement scale. Therefore, each sub-object can then be defined. In other words, each OBJ file along with a unit of measurement that tells us what the scale in that file is. The coordinates can be translated mathematically as the sub-object (i.e., the left eye or the right eye) is integrated into the composite object (i.e., the avatar). Therefore, the left eye will then reside at the proper scale and the right eye is at 10 times the scale.

In a preferred arrangement, the disclosed system and methods only require that the right eye is defined, then list the OBJ file, and then list the unit of measurement that is the native unit of measurement. And that will then contrast with a master unit of measurement, which is defined in the master file portion of the master file, a different portion of where the sub-objects file information is contained. And then in a preferred arrangement, the system and method will perform these types of calculations for each sub-object that is contained within the composite metadata file.

One advantage of utilizing such a unit of measurement structure is that the underlying OBJ file does not have to be changed or altered. This underlying OBJ file can therefore be included in the composite object file. As such, a user is free to edit a sub-component (e.g., the right eye) in the original 3D modeling software that has resulted in an original scaling challenge (e.g., 10× scale) and bring the sub-component back into that editor. The user can edit the sub-component and then bring it back out. This will not cause rendering issues in the preferred composite object world with the rendering engine technology as disclosed herein.

In addition to not defining a unit of measure, there is also no notion of directionality in industry standard OBJ file types. It is possible to list or to attach a label to the different faces that are defined in the OBJ file. In addition, groupings can be labeled to things like top or left side, right side, but it actually is not clear in terms of using these labels how to define directionality because these OBJ files only allow the labeling and/or grouping of the polygon faces of the 3D mesh.

This can be problematic when creating a modifiable digital representation, such as a personal digital representation like an avatar or other like electronic image. The presently disclosed systems and methods provide a solution to this challenge by way of incorporating certain directionality information into the master file. And so, for the OBJ that is included for, the present systems and methods define directionality by way of a plurality of directional coordinates. Such a method step is illustrated as step 245 in FIG. 4 where directionality is defined in the method of creating a master separate object file.

In one preferred arrangement, directional coordinates are utilized to indicate that the top of the object is now the maximum Y value, with no real need to reference the Z or the X. For example, FIG. 10b illustrates the “top” and the “front” directional coordinates 1480 for the sub-component “head” 1470.

In an illustrative arrangement, the left or left side of the object is represented by the most positive X coordinate value, and the right of the object is represented by the most negative X coordinate value, and then similar for the Z coordinates for representing the front and the back of the sub-object. In this preferred arrangement, the disclosed systems and methods define directionality in terms of a numerical value. This numerical value would then allow the system to understand that the top is represented by those vertices that are closest to the Y coordinate that the master data file defines as top.

With the presently disclosed creation or generation of the master file, the systems and methods assign directionality to the sub OBJ file. This is assigned in terms of what is top and bottom and left and right and front and back. Such an assignment allows those OBJ files to be oriented properly the same way that the unit of measure information for each OBJ file allows theses files to be scaled properly.

So now, the system will include a master file that contains sub-objects that are oriented properly in three-dimensional space. They are also scaled properly in three-dimensional space and they are also properly labeled.

In one preferred arrangement, the systems and methods utilize the same terminology for all directionality, top, bottom, left, right, front, back. Adopting such a manner, each sub-object that is brought into the master file will be labeled in such a manner that the system can digest and the system being anything that uses such a master file format or type.

As illustrated in the method of creating a modifiable digital representation illustrated in FIG. 4, the method includes the step of defining a unit of measurement in step 235 and then one or more of the sub-objects are assigned this unit of measurement at step 240. The process 200 continues to step 245 where the systems and methods define directionality. With these two process steps completed, the systems and methods can now be utilized to assemble the composite object from the one or more sub-object files contained within the master data file, such as the master data file illustrated in FIGS. 10 a, b, c. Now, in one preferred arrangement, the rendering engine can be implemented to virtually attach these sub-objects to one another in order to create the primary object (e.g., a complete avatar) or at least a portion of the primary object (e.g., an avatar's upper torso).

In one preferred arrangement, the disclosed systems and methods utilize one or more attach points to create a complete or semi-complete digital representation. The use of attach points is illustrated as step 255 illustrated in the method of master file creation method 200 illustrated in FIG. 4. And exemplary “attach points” 1490 for the sub-component “neck” 1470 are illustrated in FIG. 10b.

As illustrated in FIG. 10b, these “neck” attach points comprise an identification label “id”: “neck” and then the three dimensional coordinates of: “x”: 0, “y”: 0 and “z”: −25.8. These coordinates define where in three-dimensional space the neck can be virtually connected or attached to a second sub-object, like the body or torso of an avatar. And then similarly, the master data file would include a sub-object “torso” that would include an identifier as well as a set of three-dimensional coordinates defining in three-dimensional space where the body or torso would connect or attach to a second sub-object in virtual space.

Attach points, therefore, represent additional information that is listed along with the OBJ file data that identifies, what is the point, which vertex in the model is the vertex to use for attaching to some other part of the composite object. An example of an avatar sub-component that utilizes one or more attach points is the right arm of an avatar. For this right arm to attach to the composite object (e.g., the avatar body or the avatar shoulder), the system and methods need to know what it attaches to and where is the point of attachment.

And now, if a user was trying to render a smooth unified 3D object, the shoulder would give way to the arm seamlessly and all of the shading was completed, and this would require that all of the polygons are merged such that no scenes or lines exist. An ordinary user would have a difficult time to make this happen. Making a composite object would require remeshing the object in order to be able to render the object smoothly, as opposed to having break points.

However, with the presently disclosed systems and methods, this issue of sub-object merger and integration is not of primary concern. The presently disclosed apparatus and methods utilizes a three-dimensional voxelized object, such as the voxelized object 600 illustrated in FIG. 8. Alternatively, this voxelized object may be referred to as intentionally generated 3D object that comprises a lower resolution. With such a lower resolution object, a 3D object's areas, seams and rough edges that might be created during this sub-object merger and integration, are a natural part of the look and feel of the low-resolution generated object.

By using the disclosed rendering engine for intentionally lowering resolution of 3D objects results in certain advantages. As just one example, this lower resolution allows the presently disclosed systems and methods to virtually place a first sub-object adjacent a second sub-object in the correct position, that is, near an object attach point. And from a user's perspective, the attachment will look like it was properly integrated. Going back to this discussed example of an avatar's right arm, the right arm's leftmost coordinate or right arm's left side would be the side that attaches to the right side of the avatar's torso or shoulder. And this virtual attachment would occur by way of one or more attach points.

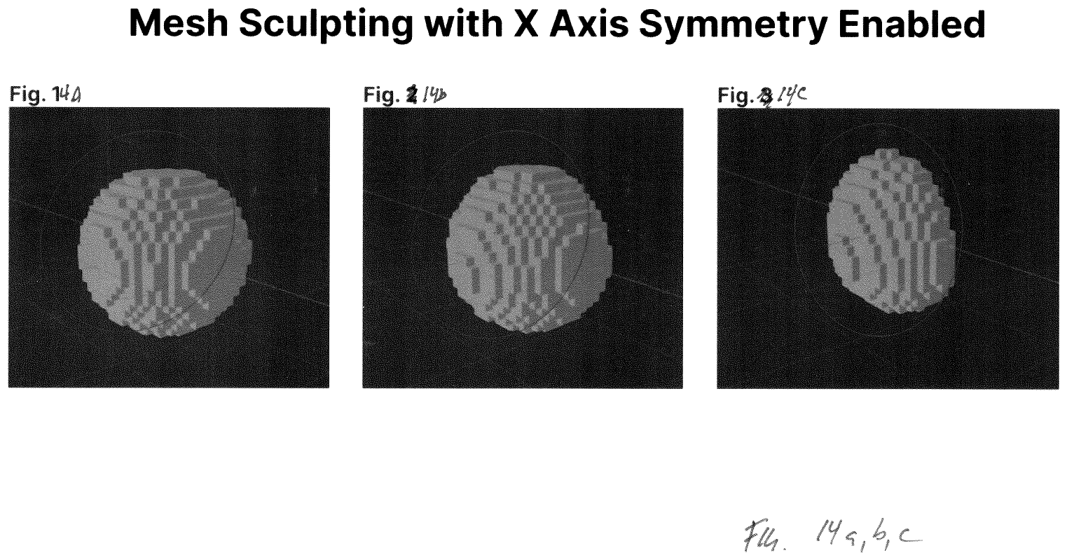

And now the torso object can be defined as some type of three-dimensional configuration (e.g., a cylindrical structure, a rectangular prism, etc.), but a rectangular prism, three-dimensional rectangle shape. Its right side has a coordinate or a vertex that is at the very top of the right shoulder. Again, the process as illustrated in FIG. 4 already has defined the object's unit of measure at step 235 and the directionality at step 245 which is also included in the master data file (FIG. 14).

Now to attach the right arm, the disclosed systems and methods will need to determine what the coordinate is for the right arm that matches to the coordinate for the left side of the right arm to the right side of the torso. And so, the presently disclosed rendering engine calculates or defines that attach point to be in or near the middle, in terms of the depth of the shoulder and exactly in the upper portion of the whole torso height.

In an alternative scenario, the attach point may be defined in terms of a portioned outcropping of the torso, that looks like a part of the arm beginning. For a particular user or avatar creator, that might be an ideal location to attach an arm. And so, to assemble the composite 3D object, the systems and methods as disclosed herein define objects that are complete in themselves with their own vertices and polygon faces. These systems and methods then utilize one or more attach points to position a sub-object near, immediately adjacent, or directly in the location defined by the attach point.

And now when rendering that 3D object under certain conditions, the rendered 3D object would normally have a seam or a break line between those two objects that were attached to one another. However, with the presently disclosed systems and methods, the systems and methods do not attempt to smooth these seams and break lines that might exist between certain adjacent polygon faces. So now the generated image looks acceptable from a perspective of a voxelized 3D model.

This is advantageous, because in the case of an avatar sub-component, like an arm, the arm is now free to rotate or pivot. That is, the position of that right arm can be altered. And if the attach point is known, the center point can also be determined around which all of these sub-component translations, and rotation occur. Therefore, in order to animate the movement of the arm lifting up as if to shake someone's hand or to lift an object into the air, the disclosed systems and methods simply need to utilize the rendering engine to compute the mathematical rotation of the arm.

And then all of the positions of the object's vertices are relative to the attach point. And it will be animated as if it is a part of the body, positioned properly relative to the torso with the attach point acting as the single pivot point. One way to analogize the present method of utilizing attach points for avatar creation is to consider a wood figure drawing modeling doll that is often used by sketch artists. All of the joints are on ball joints, such that the wrists and fists can be rotated and the legs and the knees and all of these things and they can be moved into a desired position. And the various sub-components can move around ball joints. Attach points can be considered to be a digital equivalent of such a mechanical ball joint. Preferably, each attach point can move in practically any direction. In one preferred arrangement, the attach point identifies a center point or at least near a center point for sub-component rotations, translations, and other similar types of avatar component movements.

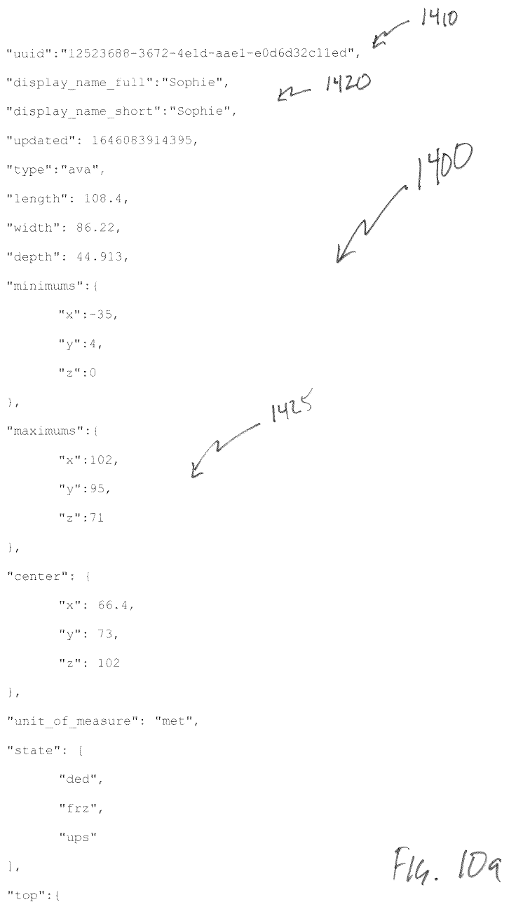

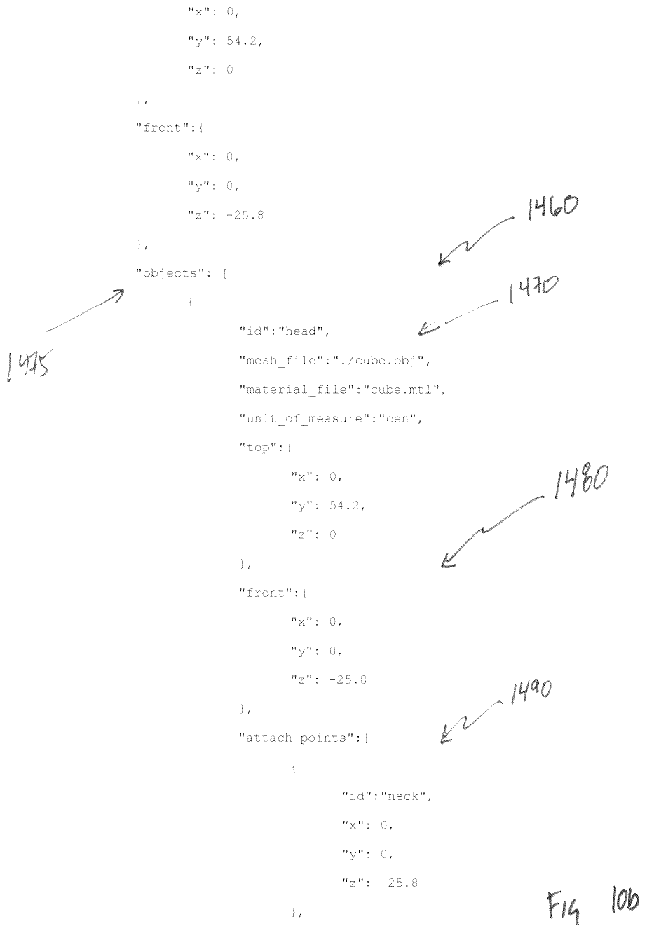

For example, FIG. 9 illustrates an exemplary personal representation that may be generated by the method and systems disclosed herein, as for example the method 100 illustrated in FIG. 3. In this exemplary personal representation, the representation comprises an avatar 1000 that is configured in association with a metadata master file, similar to the metadata master file 1400 illustrated in FIGS. 10 a, b, c.

This avatar 1000 comprises a plurality of body parts where each body part may include one or more attach points. In this illustrated arrangement, these body parts include a head 1210, a torso 1200, a left arm 1220, a right arm 1240, a left leg 1260, and a right leg 1280. The head 1210 may also include two eyes 1300, 1310, two eyebrows 1320, 1330 positioned above each eye, and a mouth 1340.

As those of ordinary skill in the art will recognize, additional or alternative body parts and/or alternative objects may also be utilized. For example, the avatar 1000 may be provided with additional or alternative body parts that include hair, ears, a nose, fingers, toes, etc. And additional objects could include clothes, jewelry, shoes, a shirt, a hat, a purse, a weapon, a shield, a helmet, etc. In one preferred arrangement, each additional or alternative body part or additional object would then be defined within the avatar's master data file.

Several avatar attach points are identified in FIG. 9. For example, the avatar 1000 comprises a left leg 1045 and a right leg 1040. The left leg 1045 includes an attach point 1045 and this attach point 1045 is utilized to attach the left leg 1260 to the torso 1200 of the avatar 1000. Specifically, the left leg's attach point 1045 may be utilized for allowing the disclosed systems and methods to determine where the left leg 1260 should be attached to the avatar's torso 1200 in virtual space.

As illustrated, the avatar torso 1200 comprises four (4) attach points: 1010, 1015, 1020, and 1025. The avatar torso attach point 1010 is utilized to attach the upper right portion of the torso to the attach point 1030 of the right arm 1240. Similarly, the avatar torso attach point 1015 is utilized to attach the upper left portion of the torso 1200 to the attach point 1035 of the right arm 1220.

The avatar 1000 includes an attach point that is utilized for allowing the disclosed systems and methods to determine where the right arm should be attached to the avatar's torso.

Attach points may be used to define the position of the eyes 1320,1330 on the face. For the creation of an avatar, like the avatar 1000 illustrated in FIG. 9, a user modifying or creating the avatar 1000 may decide that the eyes 1300, 1310 are to be much farther apart than allowed for by a standard setting. And so, the user may decide to space the eyes 1300, 1310 more to the left and the right, so as to increase the Z or the X coordinates in both directions. This edit or change is then recorded and the master data file is updated such that when the composite object, which is avatar 1000, gets built and eventually rendered, the eyes 1300, 1310 are farther apart than those of an avatar who keeps these eyes in the standard position. This standard position may be a default distance as defined by the disclosed systems and methods.

And now if it is desired to animate the raising of either the first eyebrow 1320 or the second eyebrow 1330, both the first and second eyebrows are represented by separate OBJ files in the master data file. In this manner, the presently disclosed rendering engine will not alter the rotation of the eyebrow but will alter its translated position in three-dimensional space to raise the right eyebrow and then lower it again. With the disclosed systems and methods, this will occur without impacting the rendering of the remainder of the 3D object as defined by the master file or the metadata file.

And so, by splitting out a set of polygons, that is the result of the animation, most presently available 3D rendering software programs will be able to render the scene, such that the animation takes place. But the only mathematics being performed by the presently disclosed systems and methods is in the translation of a second sub-object. In this example, the eyebrow. And this other second sub-object has no polygon faces that are shared with any other sub-object in the composite, and therefore it is free to move independently of other sub-components.

And so, the data just simply needs to be an X, Y, Z coordinate that is listed as the attach point of the sub-object OBJ file. And then that needs to correspond to a named or labeled set of coordinates on another object in the set. This acts as providing the location information required as to where to attach the sub-object.

Now the system has prepared a composite object made of sub-standard OBJ files, so in other words, standard polygon mesh object definitions, according to certain conventional 3D technologies. And so, in order to automatically animate interactions between one or more objects, the disclosed systems and methods define one or more points of interaction. For example, the exemplary JSON master data file illustrated in FIG. 10 illustrates these “interaction_points” 1495 for the sub-component “head.”

As specifically illustrated in FIG. 10c, these “interaction_points” 1495 are defined by an identification label “id”: “top of head” and then the three dimensional coordinates of: “x”: 0, “y”: 0 and “z”: −25.8. These coordinates define where in three-dimensional space the head can be virtually connected or attached to a second sub-object, like a second avatar using his or her hand to pat the head of the avatar. And then similarly, the master data file of the second avatar would include a sub-object “hand” that would include an identifier as well as a set of three-dimensional coordinates defining in three dimensional space where the hand would include an interaction point to then meet up with the interaction point “top of head” in virtual space.

Generally, therefore, interaction points as used herein are used to animate one or more objects into different positions. Interaction points will be explained by way of an example animation where a handshake occurs between two metaverse avatars that previously have never been animated to interact. This example also exemplifies the rendering engine's use of the data master file's directionality information.

Normal mode of animation would be to delicately arrange for all of the movements of the 3D models such that an animated handshake appears realistic and accurate. This can be done by having a human being understand the look and the animation sequence that is needed in order to make the handshake animation look legitimate or look realistic or satisfactory.

And so, that is because an observer who is performing the animations would know what body parts need to be aligned in the 3D mesh. The observer would also know what rate of movement would be needed to bring a first avatar into contact with a second avatar, and other related and corresponding avatar movements. And the details here would be like, if there are two avatars that are more than two arms lengths apart and they need to shake hands, it would be understood that they will need to move closer to one another. In other words, they would need to be animated as they would step towards one another, otherwise they would just slide toward each other, or they would reach to shake hands and they would not come into contact because they are too far away from one another. An observer would also understand that the two avatars would need to be animated by taking a step forward toward each other first, before their hands could shake one another.

A human animator would also understand that the right hand of the one avatar needs to be brought together with the right hand of the other avatar as they face each other. This would allow the two hands to come into virtual contact with another and align. Then the hands could be animated to move up and down while in virtual contact, and then separate. So that sequence requires some observation of the current avatar positions, as well as the respective arm positions.

With the presently disclosed systems and methods, interaction points allow animations to be performed automatically. Similar to attach points as discussed herein, interaction points also comprise X, Y, and Z coordinates (a point in three dimensional space) that are present on some of the sub-objects. These may be designated points that may also be labeled for purposes of performing one or more automated interactions or automated animations. For example, FIG. 10c illustrates a “head” sub-component “interaction_point” that is spatially situated near the “top_of_head” of the avatar defined by the master data file. The X, Y, and Z coordinates of this “interaction_point” may also be provided.

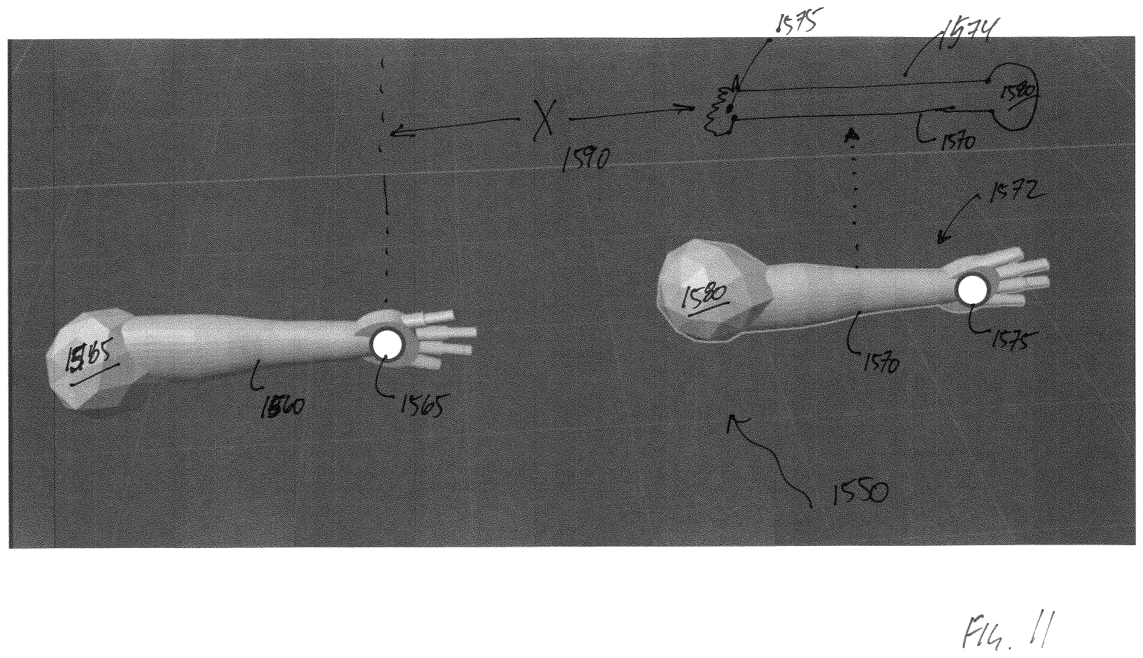

Returning now to the handshake example between a first avatar and a second avatar wherein these two avatars are separated by a couple of paces apart. For example, FIG. 11 illustrates an animation scene 1550 that includes a first-hand 1560 of a first avatar 1585 and a second hand 1570 of a second avatar 1580.

In addition, one of the avatars (the second avatar 1580) is not currently facing the first avatar 1585 and is currently turned at a 180-degree angle to the first avatar 1585. In other words, as illustrated, the first avatar 1585 is presently facing towards the second avatar 1580. However, this second avatar 1580 is currently not facing the first avatar 1585 and therefore must be rotated before a handshake between these two avatars can take place in virtual space.

From this starting position, the presently disclosed systems and methods automatically animate this handshake between these two avatars but will determine that it will first need to rotate one of the avatars to initiate the animated handshake. Well, so now since interaction points are three-dimensional coordinates that allow the present systems and methods to label a point for purposes of interaction, in one preferred arrangement, each avatar hand will define at least one interaction point. For example, a first interaction point may be defined on or near the palm of each avatar hand 1560, 1570.

FIG. 11 illustrates a first hand 1560 of a first avatar 1585 and a second hand 1570 of a second avatar 1580. For illustrative purposes, only the hands of these two avatars 1585, 1580 are illustrated. As those of ordinary skill in the art will recognize, such an avatar may comprise any type of avatar, such as the avatar 1000 illustrated in FIG. 9. In addition, either or both of the first and second avatar may be rendered by way of a master data file as disclosed herein, such as the master data file illustrated in FIGS. 10 a, b, c.

As can be seen from FIG. 11, the second hand 1570 of the second avatar is turned in an opposite direction, away from the first hand 1560 of the first avatar.

And so, the master data file for the first avatar 1560 may define a first interaction point identified with the title of “right_hand_palm,” or “right_hand_touch.” That label will be used to define a three-dimensional coordinate that will allow the presently disclosed rendering system to find a way to get that three-dimensional coordinate to touch or to overlap in three-dimensional space with the second interaction point for the purposes of this animated interaction.

Since the interaction of this exemplary avatar interaction represents a handshake between these two avatars, this means that the systems and methods want to have that first interaction point 1565 of the first avatar's hand 1560 to come into contact with the second interaction point 1575 as labeled on the second avatar's hand 1570. To bring those two interaction points 1565, 1575 together, the disclosed systems and methods can perform some calculations regarding a distance “X” 1590 between these two interaction points in three-dimensional space.

Because this distance “X” 1590 exists between these two extended avatar hands and particularly between the avatar hand interaction points, the disclosed systems and methods will determine that the first and second interaction points are currently far enough apart that the rendering engine will need to move the first and second avatar hands closer to one another. In the presently disclosed systems and methods, these avatars will move through a sequence of taking steps. The rendering engine will determine that it will need to execute the take step sequence in order to bring these two avatars closer together until they are at arm's reach of one another.

However, before the first and second avatars start to move closer to one another, the rendering engine will need to turn one of the avatars around so that the two avatars 1580, 1585 would now face one another in three-dimensional space. Again, the rendering engine will detect that the second avatar 1580 is currently not facing the first avatar 1585. So, the first avatar 1585 is ready to take a step forward, towards the second avatar 1580 but the second avatar 1580 needs first to turn so as to face the first avatar 1585 to initiate the handshake animation. This movement may be described as an animation sequence that can be defined, turn and face. The disclosed rendering engine can run that animation sequence whenever there is a need to reorient an avatar toward a second object, such as a second avatar or another virtual object.

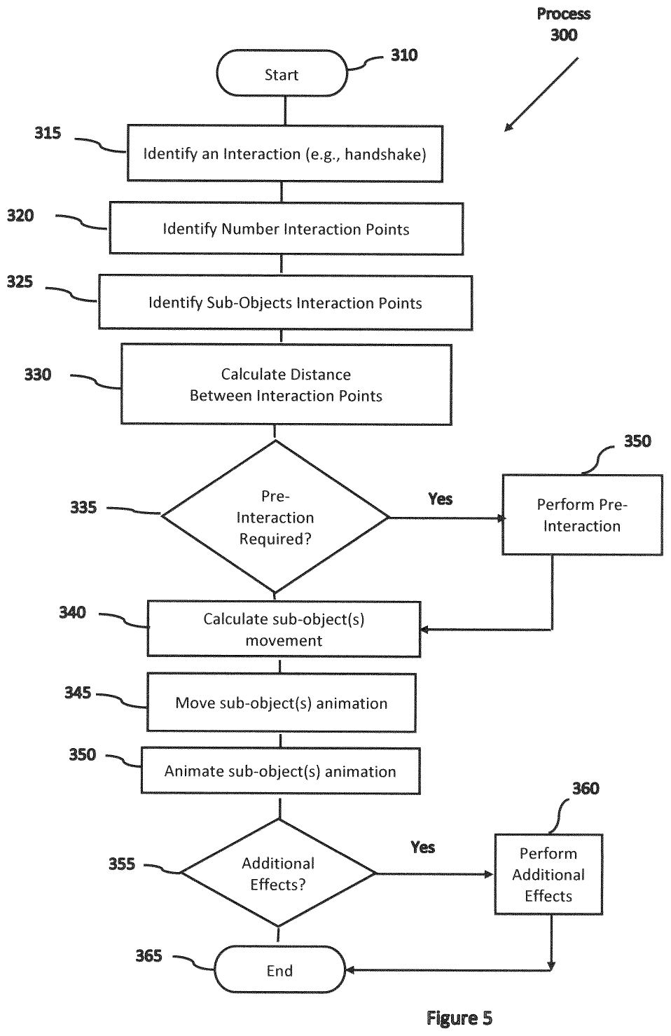

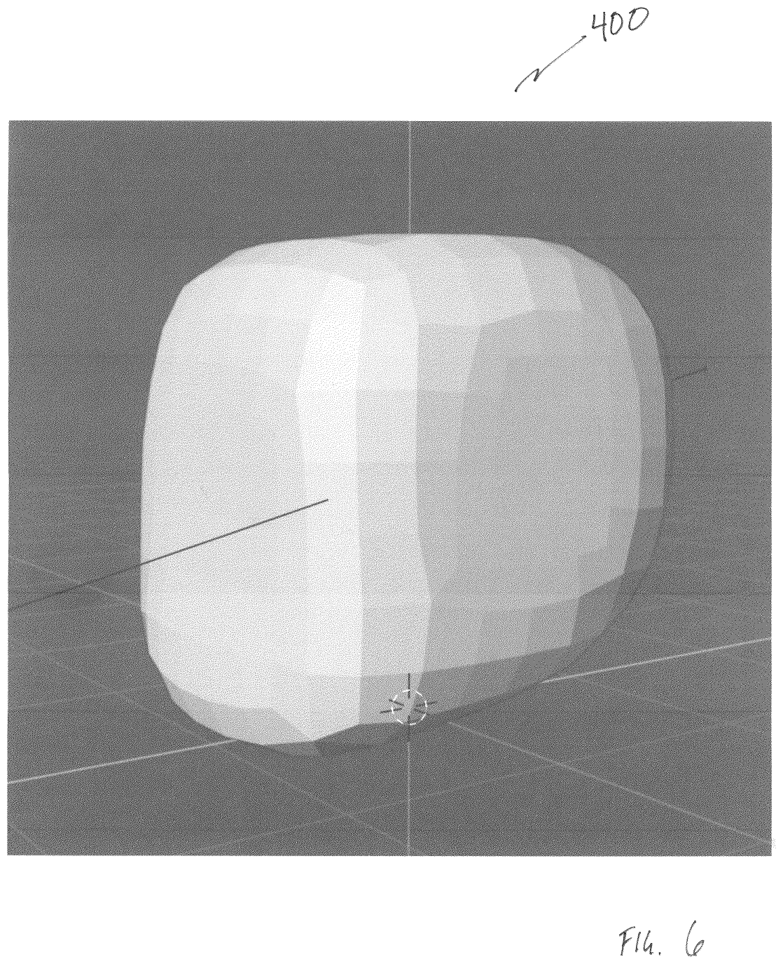

As described herein, the metadata file (like the metadata file illustrated in FIGS. 11 a, b, c) includes directionality defined which can indicate that there is a front and a back for a particular sub-object, like a hand, or a head, or a body. Therefore, the disclosed rendering engine can use this directionality to orient the front of the second avatar 1580 towards the first avatar 1585 as a first step in performing the handshake animation. Then, let us perform the animation to bring the first and second avatars into sufficient proximity for performing a required pre-interaction step (i.e., first and second avatar handshake). This pre-interaction step is illustrated as step 335 in the animation method 300 illustrated in FIG. 5. Turning or repositioning the avatar is one type of pre-animation or pre-interaction step that may be needed in order to bring the first and second avatars 1580, 1585 into a condition in which a desired virtual animation interaction is possible.

Returning to FIG. 5 which illustrates a preferred animation process 300, the rendering engine of the presently disclosed systems and methods therefore performs these pre-animation steps at process step 350. Thereafter, and now in three-dimensional space, the second avatar 1570 has been repositioned in virtual space from a first position 1572 to a second position 1574.

Thereafter, the two avatars are now facing each other. Turning towards one another may be considered performing a first required pre-interaction interaction. Returning to the process 300 illustrated in FIG. 5, this may be accomplished during step 350.

The rendering engine then determines that a second step must be accomplished, and then calculates the avatars movement towards one another. Returning to the process 300 illustrated in FIG. 5, this step of calculating avatar movement may be accomplished during step 340. Once this movement is calculated, the rendering engine then moves the first and second avatars in virtual space at step 345.

The avatars now reside in arm's length position of one another. They are now close enough to one another to perform, according to a measurement carried out by the rendering engine, the handshake interaction. Now, at step 350 in the process 300 illustrated in FIG. 5, the rendering engine performs the animation step of bringing the first animation point 1565 of the first avatar hand 1560 and the second interaction point 1575 of the second avatar hand 1570 together. In order to accomplish this movement, the rendering engine calculates based on rigid body and joint animations, how the arms will need to move in order to bring the two hands together for a handshake.

And so in calculating that these two avatar hands need to be moved toward each other, the rendering engine animates the movement of the hands. The rendering engine determines from information contained within the master data file that the animation can illustrate the wrist pivoting, which is an attach point for the hand, to the forearm. The rendering engine pivots and moves the forearm with an attach point at the elbow, which is for the upper arm, and also moves the upper arm as needed with an attach point that attaches to the shoulder.

And now, during this handshake animation, movement of the remainder of the avatar body might not be desired. Therefore, the rendering engine basically animates the extension of the arm with a couple of flex points, and the rest of the avatar components are rigid bodies. This is an animation calculation that can be performed, because in a preferred arrangement, it is assumed that the avatars possess rigid bodies for the arm segments. And the rendering engine determines their relative position with respect to one another in space as the avatar hands 1560, 1570 are moved to a new position.

And that new position is a center point for the two avatars where their hands will meet, and both animate their right arms toward that position. As the right hands move towards that position, the right arms follow with rigid body physics. The hands are then animated into a position where they are in contact, where the interaction points have met in three-dimensional space. And those interaction points 1565, 1575 are what the rendering engine is using to perform these calculations. The rendering engine performs all of these calculations of how far these interaction points are apart from one another and what avatar body parts need to converge.

Now that the hands are put together, the rendering engine animates those interaction points moving up and down, up and down, in a couple of motions over about one second or so. And this is the animation of the handshake motion, of shaking these two hands up and down. In one arrangement, the systems and methods do not need to animate the hands clasping each other, because in a lower resolution, in a voxelized 3D world, the resolution is low enough that there is no way to tell that the hands have clasped. Therefore, with the presently disclosed systems and methods, these two hands 1560, 1570 come into contact with each other and reside adjacent to each other for performing this animation.

The rendering engine performs the up and down motion, and then it animates in reverse. The engine animates the hands, the interaction points, back to the resting location which is at the side of each avatar. In other words, the animation allows the arms to droop as in a resting position. And the handshake animation then is completed.

In one arrangement, the rendering engine may determine that during the animation, additional information of effects or animation components that we want at the different stages may be required. This is illustrated as process step 355 illustrated in the method of animation 300 illustrated in FIG. 5. As an example, when the hands come into contact, the rendering engine could show that the handshake was successful by performing another process step such as animating a small flurry of particle effects. This process step is illustrated as step 360 illustrated in FIG. 5.

Alternatively, the engine could play a sound indicating that the hands have come together for a successful handshake. This might be useful for something like giving someone a high five, or smacking somebody on the back, patting somebody on the back to indicate they have done a good job. Sound or particle effects could indicate that the interaction has been completed successfully and would be an enjoyable way to watch the animation sequence unfold. As those of ordinary skill in the art will recognize, alternative actions or effects may also be utilized.

Therefore, interaction points are defined points on an object in the systems and methods of the presently disclosed systems that allows for defined interactions to take place with that object. It is therefore the point that is used to calculate animations and allow an object for example to be held by an avatar. For example, the interaction point handle on a hammer would allow the avatar to animate picking up and wielding the object.

Any number of interaction points may be provided for any object, because these points may be defined as a point in three-dimensional space with a label. They belong in the master data file that is used for each object, which is a composite object in the rendering engine.

Aside from avatars, objects will also have interaction points. For example, a tool like a hammer may comprise an interaction point called handle, which in one arrangement would be positioned near the center of this three-dimensional object. This would then mean that an avatar, such as the avatars 1580, 1585 illustrated in FIG. 11, could hold the object by animating either the left- or right-hand grasp interaction point to align with the handle interaction point.

And here is also directionality, so then the hammer would have a top and it would be oriented upward toward the top of the avatar, and then this would allow for proper positioning, and then the avatar can hold the hammer. The hammer may also have an interaction point labeled as “strike,” which would be at the head of the hammer. This interaction point could allow for the hammer to be animated hitting something, like hammering a nail or breaking a vase of a piece of glass or mending a piece of furniture that is made of virtual wood. The hammer could be illustrated to strike by animating the strike interaction point to align with the nail's interaction point, also perhaps labeled “strike.” And so, this is how animations can be performed automatically without prior knowledge of the objects and avatars that are involved in an animation scene, such as the animation scene 1550 illustrated in FIG. 11.

Interaction points may also be defined on the body of the avatar and these allow interactions to occur with that avatar. For example, returning to the avatar 1000 illustrated in FIG. 9, the avatar 1000 may include an interaction point 1360 on the avatar's head 1350. This interaction point 1360 could be used for such things as placing a hat on the head 1350 of the avatar. Therefore, in one arrangement, the head 1350 may include an interaction point for wearing a hat.

Alternatively, the head 1350 of the avatar may comprise several interaction points which could be located on the front and back, and also placed on the left and the right, allowing the hat to align nicely on the avatar 1000. The rendering engine may also be utilized to provide interaction points on the left and/or right shoulders and center of back of the avatar for different types of touches. These could be used for certain animation actions or animation effects such as patting an avatar on the back, or where to grip an avatar such as when one avatar hugs a second avatar.

One of the functions of the disclosed rendering engine technology is to transform a composite 3D object into a voxelized 3D mesh, preferably on demand. This process step is captured as step 155 in the process 105 illustrated in FIG. 3. For example, FIG. 7 illustrates a composite 3D object representing an avatar's head. This 3D object comprises a plurality of sub-component objects. These plurality of sub-component objects include the avatar's hair, ears, nose, and neck. Additional sub-component objects may also be provided. Each sub-component part will be identified in the object's master data file as herein described in detail. And FIG. 8 illustrates a voxelized version of the composite 3D object illustrated in FIG. 7.

In one arrangement, such a voxel transformation maybe be required to occur for every frame of animation. Alternatively, this transformation may take place using the rendering engine to voxelize a model that was previously saved to disk. The rendering engine may then save the revised or newer version of the model to a disk. In other words, make a voxelized copy of the model.

Regardless of at which speed or how frequently it is used, the voxelization process that is utilized by the rendering engine is essentially the same. This process may be referred to as real time voxelization because the voxelization may be performed as quickly as possible. In one preferred arrangement, the disclosed rendering engine utilizes an algorithmic approach that requires no checking and fixing, but rather gives an output that is ready to be either rendered or saved or further edited.

An example object for voxelization is a sphere because a sphere, in a pure 3D sphere object, will comprise a large number of polygon faces. Ideally one could also have mathematical calculations that describe each point that makes up a sphere. Therefore, it is intended to be smooth and usually when rendered it literally looks like a real sphere, in which it has no edges.

To voxelize a sphere is a very good example of the process because it is all made up of curves. If we have a sphere that is one unit high and one unit wide, and one unit deep, then what we have is a set of coordinates in which we have X, Y, Z numbers. At the maximum of the X and the Y and the Z, it's negative 0.5, positive 0.5, et cetera. This is a three-dimensional coordinate space. Now to voxelize this round 3D model, a process is required that can be computed automatically. Such a process begins with having a calculation for where voxels will lie in a given three-dimensional space. If a bounded three-dimensional space is provided having 100 units in all directions, then we now have a three-dimensional space that can voxelized and cubed up.

Now to cube up the space, the disclosed systems and methods are quantizing three-dimensional space instead of allowing for infinite granularity. So that means that in a hundred-unit, three-dimensional space, it might be decided that a single unit is one meter. Therefore, the system will have a hundred meter, by a hundred meter, by a hundred-meter, three-dimensional space, and a one meter, by one meter, by one meter sphere existing in the center of it. If it is decided that the required voxel resolution is 10 voxels per meter, then there is now a hundred-meter direction, and the system now has 1,000 voxels in every given direction. Therefore, the system has not done anything to change the space. Rather, the system has simply performed a calculation indicating that there is a voxel defined at every one 10th of a meter increment, in all directions.

This allows the presently disclosed systems and methods to describe that three-dimensional space, not in terms of pure X, Y, Z coordinates, but in terms of voxel numbers, that would be assigned to the ordered voxels that would make up that space. There is no limit to the space, and there is no particular labeling needed for each of the voxels. The thing to note is that a voxel can be addressed in this space by an offset method. And so, to find the 10th voxel in the space, the rendering engine needs to know from which direction ordering shall begin. And then we could say, “Okay, well, what are the bounding coordinates of the 10th voxel?” If we start from the very upper left of the three-dimensional space and call that voxel zero or voxel one, then the 10th one in would simply be the size of a voxel multiplied by the count.

So the 10 voxel coordinates would begin at nine times the voxel size and would end at 10 times the voxel size. And that is a space in which the voxel occupies. The purpose of this description here is to illustrate that voxelizing or quantizing a three-dimensional space does not require having knowledge of every voxel. This is so since every voxel is identical and one can source the coordinates for a voxel, simply by applying it, the voxel size to the offset. And so that allows the present systems and methods to avoid performing any calculations on the voxels that surround the sphere and only look to the sphere itself for doing model voxelization. And performing voxelization is not a matter of transforming the 3D mesh of the sphere. Rather, it is actually a matter of identifying which voxels should be present and which should not be present.

And so, if we take the bounding coordinates of the sphere, which is plus 0.5, minus 0.5 in all three directions, it can be determined that there are five voxels in both directions, from the center, that will be part of the voxelization analysis. And that is because each voxel is one 10th of a unit. And so we are going one half of a unit in each direction. To perform the voxelization, the systems and methods will move through all of the voxels that would be contained within the bounding box or rather the bounding rectangle prism, that fully encompasses all mesh coordinates for the original 3D object. And a sphere is a very good example because it is uniform in all dimensions. So, the bounding box first sphere can be calculated by taking the maximum and minimum Y coordinates, the maximum and minimum X coordinates, and the maximum and minimum Z coordinates.

And this is not unique to a sphere. In fact, the bounding box, which is a rectangular prism, for every three-dimensional object can be found by taking the minimum and the maximum of its X, Y, and Z coordinates, and using that information to construct the rectangle. This rectangle then defines the space in which we need to evaluate voxels. And so, the bounding rectangle that surrounds a 3D object is essentially the space that should be focused on in terms of counting voxels and parsing the space. And in the case of the sphere, there is now the same number of voxels in each direction, 10 voxels wide, 10 voxels deep, and 10 voxels high. And voxel zero would be then the upper left first voxel, for the bounded rectangle. And if we begin with that and proceed through all voxels that are contained within that rectangle in order, for each voxel, the disclosed systems and methods can calculate whether the original 3D mesh of the object contains a vertex and a plane.

Or a vertex and a face or a set of vertices and faces that would cover a certain percentage of the voxels volume or not. And this percentage can be adjusted. In one preferred arrangement, this percentage shall be set to 50%, so in voxel zero, and the system has yet to encounter any of the vertices and faces of the sphere, 3D object. So, that voxel will not be turned on, it will not be activated. If the system proceeds through the rest of the voxels in order, the system will eventually arrive at voxels that do have 3D mesh vertices and planes contained within them. And for each of those voxels where vertices and planes are contained, in one arrangement, the rendering engine will perform a calculation. What would the coordinates need to be inside that voxel, the coordinates of the vertices, what would they need to be in order to comprise 50%? That is then compared to the actual coordinates of the vertices that belong to the 3D mesh. That is one approach that may be utilized for creating a voxelized mesh which is illustrated as the method step 155 in FIG. 3.

Another voxelization approach that the rendering engine may perform relates to a volume calculation. In such an arrangement, the rendering engine computes the volume of the voxel, which is one by one in voxel terms. With such a method, the 3D mesh vertices and planes that are contained within that voxel that reside along to the 3D object, could be temporarily recalculated as a segment of the 3D mesh. With this 3D mesh, the vertices that have been defined already are used as non-truncated vertices, such as the round part of the surface.

And then additional vertices can be temporarily defined that reside along at the outer bounds of the voxel. In other words, making a three-dimensional slice of the object temporarily, that looks like a voxel chunk has been taken out of the object, where then the original vertices and planes of the 3D object remain intact, and the rest is filled in. This would then be a three-dimensional shape for which the volume could then be calculated.

And that volume could be compared to the total volume of the voxel so as to determine a percentage. This is an alternative approach to performing the voxelization calculation. For the purposes of the presently disclosed rendering engine, any calculated approach that achieves sufficient render speed or calculation speed and is sufficiently accurate for determining the percentage of voxel occupation and would be applicable. The various embodiments of the presently disclosed systems and methods may use these alternative approaches.

In one arrangement, the rendering engine identifies where the vertices reside and where these vertices reside if they were 50% or greater. The rendering engine can then make a calculation for each voxel in the series. That is, whether or not that voxel should be activated based on the 3D mesh vertices and planes of the original object that fall within it. And as the engine proceeds through the object, the engine will accumulate a set of voxel numbers that are activated. The engine then calculates a position in three-dimensional space that each of those voxels occupy.

This can be computed by using their voxel number and by multiplying by the voxel size. This may be referred to as an offset method. That would then allow the engine to draw the voxels by drawing cubes in every set of coordinates for which there was an activated voxel. No cubes would be used for the voxels that have not been activated. The result then is a new secondary 3D mesh that comprises cubes. This secondary mesh may be described as an aggregation of cubes that is generated into a voxelized version of the underlying 3D object.

There are a number of alternative voxelization methods that may be utilized, and these are summarized below.

In one preferred arrangement, the systems and methods disclosed herein are not used to define voxel, mesh, coordinates, and faces that exist on the interior of the object, because that data may not useful. There is no way to render an object unless we would like to render transparency and interiors, which is possible. So, just note that is optional, to render a transparent object with interior voxel, showing that it is comprised of interior voxel, should we so choose. But let's discuss avoiding that because that makes for a 3D mesh, in which the exterior vertices and planes are the only objects of concern. In order to do this, what needs to be known when a voxel has reached the point of the interior and the method of doing that, is to know that that voxel is contained entirely within the 3D object, that we are scanning and voxelizing, and no vertex of the 3D object actually exists inside the voxel.

And so, in other words, an outer point of the sphere will reside in a voxel space, will have a vertex that actually exists inside the voxel coordinate space. But immediately below that voxel, there will be a voxel for which there is no vertex of the underlying 3D object inside the voxel space. Yet we can determine that the voxel resides on the interior of the 3D object, because by performing calculations on the boundaries of that 3D object, it can be determined that the voxel resides within its interior. The voxel resides at a position that is less than its maximum X, Y, and Z in all directions or greater than its minimum. And actually, rather the voxel resides at a position that is less than its maximum and greater than its minimum in some number of coordinates, which indicates that the voxel resides on the interior yet there is no vertex inside the voxel space.

That means the voxel resides on the interior, and therefore the system and methods can avoid activating that particular voxel because it does not serve a purpose. And this will allow the systems and methods to have an exterior voxelized model. There is one further point of refinement that can be utilized, which is that for voxels that have been activated so as to create the voxel mesh 3D object, which is a drawing of a number of cubes, in a preferred arrangement would be to avoid having repeat planes. And that means that interior planes where two voxel cubes are immediately adjacent to each other on the same X or Y or Z axis are not desired, because at least one of those planes is shared and does not need to be defined. The rendering engine can perform a similar set of calculations now for every voxel to determine if they are interior vertices.

Another alternative voxelization method concerns the process of building the voxelized 3D mesh. Voxels that are activated because they are numbered, and they are sequenced reside in a quanti space. We can say that voxel number one, and voxel number two, when both are activated are already known to share a face, and this would allow us to skip the generation of the vertices in making the model. And the way that this can be avoided is by having a map for activated voxels, which activated voxels are adjacent to them in all directions.

And that allows the engine to then build the vertices and the planes of the voxelized 3D mesh, in a more efficient manner by avoiding interiors and not generating them, as opposed to detecting interiors and then removing them. This is because, in one preferred arrangement, it is an efficient method that can be utilized to generate based on an understanding of which voxels are adjacent to each other. And therefore determine, which joint faces can be avoided. So, in this process the rendering engine creates a voxelized 3D mesh. This voxelized mesh is separate from the underlying sphere 3D mesh that the rendering engine has scanned. This voxelization can occur in a 10 to one quant space, meaning that for one meter in our three-dimensional space, the engine is working with a resolution of 10 voxels per one meter.

This is a flexible parameter and the percentage of volume of a voxel required in order to activate the voxel is one that is flexible. If it is decided that a better looking voxelized model can be generated whenever 30% or more of a voxel volume is occupied by the underlying 3D mesh, that is a parameter of the rendering engine that can be adjusted or modified by the user. In one preferred arrangement, trying out different voxelization settings is a user setting that can be activated by a design tool in order to change or alter the appearance of the voxelized mesh.

Allowing voxels to be activated when a lower percentage of their space is occupied results in more voxels being activated. And therefore, more voxel content is generated with less underlying 3D mesh content, which may under certain circumstances be beneficial. In a way it is a method of amplifying a 3D object, extending small details into larger objects. And the inverse is true by setting the percentage requirement much higher, say setting it at 80% and therefore requiring an 80% fill rate prior to voxel activation. In such a scenario, unless a voxel space is almost entirely filled, it will not be activated.

Such a situation results in a reduction of the size of the voxel model relative to the underlying 3D object. Such a situation would therefore tend to mask detail and reduce the object to a smaller representation. Since this is flexible with the disclosed rendering engine, it may be beneficial to change this setting depending on how far away an object is from the view that the engine is rendering. That might allow for a lower number of vertices and polygons and therefore faster rendering.

Now the same applies to the level of quantization. If users of the disclosed rendering technology would like to have 100 voxels per one unit in the three-dimensional space, the rendering engine could perform the same set of calculations. However, the rendering engine would perform the calculations more often in order to account for the larger number of voxels that fit into the same three-dimensional space. Therefore, there would be a larger number of voxel evaluation calculations completed on the same underlying 3D mesh of the original object.

But the technology in the approach is essentially the same. It is worth noting that although the volume of voxel increases cubically when the resolution is increased, the surface area of the underlying 3D model does not increase cubically, it increases as a square. And so the calculation of the interior, the voxel interior can be important to keeping speed while doing this real time voxelization, if the surface area, in terms of the number of voxels increases as a square, not a cube, upon increasing the resolution. It is preferred to utilize the disclosed systems and methods to compute the fastest method of determining that a voxel space is on the interior of the 3D object, in order to eliminate spending compute power and resources on those voxels and doing that evaluation. In a preferred arrangement, the systems and methods disclosed herein apply the compute power onto the meaningful voxel evaluations, which are the voxel evaluations that coordinate with the actual surfaces of the 3D, and not the interior space.

The beneficial approach would be to find an efficient method to determine that a voxel space is on the interior of a 3D object. In this way, the system can skip evaluating the voxel volume percentage and move on to the next voxel as quickly as possible. So, because the quantization is flexible, that means that 3D objects can be rendered and re-rendered in voxel form on demand. It is therefore possible to change the voxelization resolution from one render frame to the next render frame.

This would make it possible for the rendering engine to zoom in on a 3D object that has been voxelized. For example, this might occur during an animation in which the rendering engine zooms in on the face of an avatar in the metaverse. The system could zoom in and enhance or increase the number of voxels representing the face of that 3D avatar as needed.

The rendering engine could retain a voxelized look and feel but would generate an increased number of voxels representing the underlying 3D object when needed. Alternatively, the rendering engine could pull back the camera view and choose to re-quantize the space on a frame by frame basis. This would result in flexibility in the level of detail that the methods and systems could display and making a flexible rendering engine for the way that the image can be voxelized and quantized in space.

As called for by the method step 160 illustrated in FIG. 3, it may be determined that the voxelized 3D mesh generated by step 155 will need to be edited. If it is determined that the voxelized 3D mesh is to be edited, the process moves to step 162 where the rendering engine can be used and manipulated to edit this 3D mesh.

Typically, when editing 3D objects, an editing tool would normally add and remove vertices. Such an editing tool would then reconnect or reconfigure the planes and the polygons that fit into the vertices that are on the outer surface of this 3D object. And this is how 3D objects would be drawn, redrawn, and edited. In a voxelized version, however, editing is different, and the calculations needed to be performed are also different.

This can be illustrated by way of an example. Assume that the 3D object represents a sphere and that this sphere has been voxelized. For this example, assume that the original sphere has been voxelized at a 50% voxel fill rate, and the rendering engine uses a voxel resolution of 10 voxels per unit. The rendering engine would generate a fairly rough-edged representation of this sphere, with a relatively low resolution of 10 voxels in all three directions. As a user of the disclosed rendering engine, if the user wanted to edit the sphere by removing the upper left most voxel, that is part of sphere, the user can utilize an editing tool that simply allows the user to tap, or click, or right click and choose delete, or choose an eraser tool and tap on that voxel.

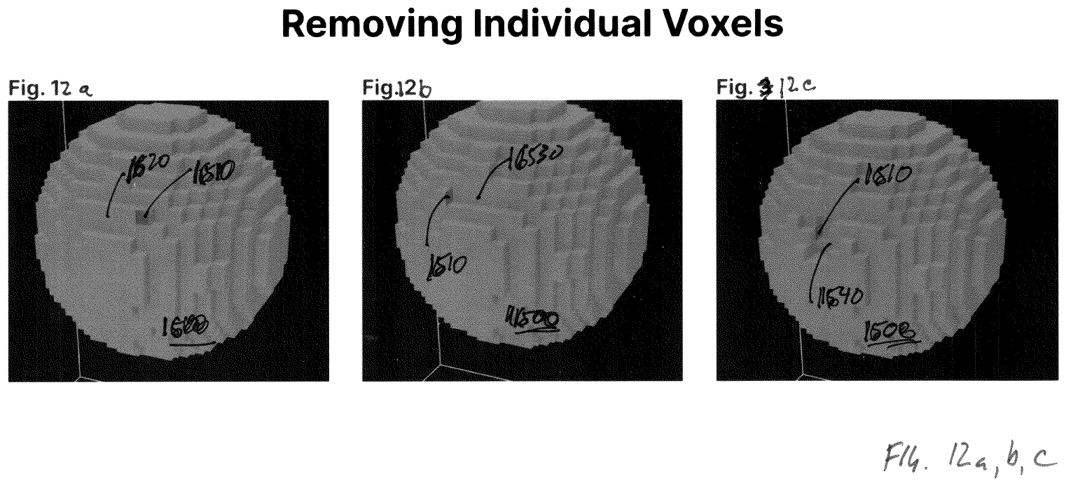

For example, FIGS. 12 a-c illustrate various steps for removing individual voxels from part of a sphere 1600 by using an editing tool 1610. More specifically, FIG. 12a illustrates how the editing tool 1610 can be utilized to select a single row of voxels 1620 from the voxelized sphere 1600. FIG. 12b illustrates the removal of this row of voxels 1620 and FIG. 12c shows the editing tool 1610 being moved to a subsequent voxel area of the sphere 1600 to continue the editing process. As just one example, the editing tool 1610 may be provided as part of the disclosed rendering engine that allows a user of a computing unit, such as the computing units illustrated in FIGS. 1 and 2, to perform certain voxel editing and revising processes.

In doing so, the user would then know that the selected voxels should not be activated. And that means that the rendering engine would remove those inactivated cubed vertices and planes from the voxelized 3D mesh.

The status of the underlying 3D object that the user has voxelized may be altered or it may not be altered during an editing process. For example, in one arrangement, the rendering engine could leave this underlying 3D object untouched. And the user could simply remove the voxels and deactivate the voxels that were assigned for activation during the voxelization process and therefore have an underlying 3D mesh that is voxelized. Here, the voxelization represents a separate mesh and is edited completely independently of the underlying mesh. This may be of value because a user may wish to adjust this voxelized version without changing the underlying 3D object. And therefore, voxel removal does nothing to the underlying 3D mesh, but the voxelized 3D mesh has been altered.

Alternatively, the underlying 3D mesh may be altered during the voxelized 3D mesh editing step illustrated as step 155 in the process 105 illustrated in FIG. 3. If the user would like to change the underlying 3D object that has been voxelized, the presently disclosed systems and method could perform this function as well. One approach for modifying the underlying 3D object is to treat each voxel as representing its most pure set of vertices and planes that would comprise its targeted ratio (50% in the previous example). And so that would mean each voxel can be thought of as having a center vertex and below which the planes are attached and therefore below which the volume is filled and above which the volume is not filled. Therefore, in this exemplary illustration, that would be the 50% level.

And if a user removes a voxel from the voxelized sphere, the underlying 3D object sphere mesh could be changed such that the rendering engine would now recalculate and then change the set of vertices. As such, the underlying 3D mesh of the sphere now has a new set of vertices that have been added if they were present in the center point of the next voxel behind the one that has been removed.

From a voxel standpoint, the rendering engine removes a cubic chunk out of the 3D model. However, in terms of the smooth underlying sphere 3D model, the rendering engine moves to the next voxel center vertex, as the replacement vertex for the one that was removed. And that would put, if one would look at the re-render, that 3D sphere object, without voxelization, it will look like a dent, as opposed to a cubic chunk has been removed from the model. This is a fairly close approximation to what one would anticipate it would look like after removing a voxelized chunk. Upon re-voxelizing of the altered 3D sphere object mesh, the voxel model should look similar to the voxel model in which the voxel was removed.

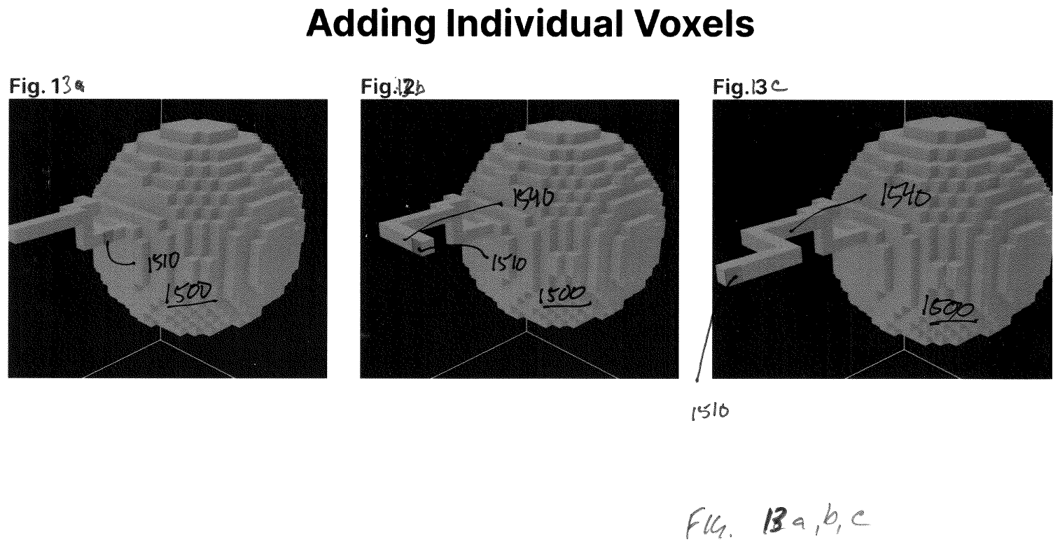

The rendering engine can use a similar process in reverse to add voxels to the underlying 3D mesh. For example, FIGS. 13a-c illustrate various steps for adding individual voxels to part of a sphere 1600 by using an editing tool 1610. More specifically, FIG. 13a illustrates how the editing tool 1610 can be utilized to add additional voxels 1640 to the voxelized sphere 1600. And again, as just one example, the editing tool 1610 may be provided as part of the disclosed rendering engine that allows a user of a computing unit, such as the computing units illustrated in FIGS. 1 and 2, to perform certain voxel editing and revising processes.

FIG. 13b illustrates the addition of these voxels 1640 and FIG. 13c shows the editing tool 1610 being moved to a subsequent voxel area of the sphere 1600 to continue the editing process. In doing so, the user would then know that the additional voxels should be activated. And that means that the rendering engine would add these activated cubed vertices and planes to the voxelized 3D mesh.

This would then add vertices and planes to the underlying 3D mesh, which is essentially extending existing vertices and planes into a new set of coordinates that would correspond to the voxel that was added at a 50% rate.

And therefore, the underlying 3D mesh object would also re-voxelize identical to the voxel model that was being edited. This would be an adequate approximation to what the underlying 3D object would look like, if it was voxelized in this manner.

There are opportunities to increase computing performance by storing the voxelized model that has been executed. Storing such a voxelized model might be beneficial since the voxelization calculations might not need to be performed again. For every 3D model that has been voxelized and where the 3D model has not changed, the presently disclosed systems and methods could use the same voxelized 3D model, 3D mesh to represent that object, until a change occurs. As such, there is no reason to re-perform the voxelization on every frame of an animation, unless something is changed or altered in the underlying 3D model. Consequently, this would mean that objects that remain static need to be voxelized only once.

And then the system can cache that voxelized 3D mesh and use that and draw it directly from storage on disk or storage in RAM memory. This storing or caching step is captured as step store voxelized 3D mesh 165 in the method 105 illustrated in FIG. 3. This voxelized 3D mesh can be transmitted over a computer network from one computing device to another computing device such that the rendering only needs to be completed in one location, if the underlying 3D object never changes.

The present systems and methods can also export that voxelized 3D mesh for various purposes. In other words, the voxelized 3D mesh can be stored on a disk or it can be merged with the original 3D object model as an additional set of vertices and faces. This allows for a composite object to be rendered showing what voxelization effect looks like.

In one arrangement, the rendering engine can define the look and feel of the voxelized 3D model, meaning that the system can make the faces transparent or colorized or add borderlines. One advantage is that caching can therefor improve overall system performance. In addition, caching also allows for the distribution of voxelized models. In one arrangement, the disclosed rendering engine only needs to repeat the voxelization process if something has changed and a user has a desire to see the updated or a revised output.

In one arrangement, the present rendering engine operates in part as a combination between a 3D editor and a voxel modeler. This means that with the presently disclosed systems and methods, users can edit the underlying smooth 3D mesh while at the same time seeing in real time how it affects the voxels representative of the underlying 3D mesh. One advantage of this type of arrangement is that a user can see in real time how it is affecting the voxels which adhere to the general shape of the 3D mesh. The user implementing this technology can use a more organic, more natural, more intuitive input, rather than be required to go in and individually select and click each voxel, one by one in order to make changes to the underlying 3D model. With the present disclosure, someone designing a 3D model such as an avatar can use tools that are more akin to what it is like to model with clay or other sculpting material virtually and allows for a more ergonomic experience.

The way that this works is that the 3D mesh can be affected in a much more subtle way in which the points can exist in a fine resolution in 3D space. Whereas the voxel grid consists of a point cloud with voxels that are turned on or off, depending on their relation to this 3D mesh. For example, if a voxel is inside the 3D mesh and would make up the border of the voxel model, the outward facing sides of the voxel model are turned on such that it appears to be a single voxelized shape from the outside. But this voxel model does not have any excess volume on its interior.

A user is then able to smooth the 3D mesh, which slowly takes form and molds to the area that the user is smoothing, for example. And then when it is appropriate, the voxels will turn on or off to closely model that smoothing process. An example of this would be if there is a sphere 3D mesh, and it is filled with voxels, or it appears to be filled with voxels, but it is really just the exterior walls displaying to the user. And then if a user were to smooth the right-hand side of this 3D mesh using a single finger or a multi-finger movement along an active touch sensitive interface (see FIG. 2) of a computing device (like a desktop computer or smartphone display, see both FIGS. 1 and 2), using such a tool that removes or deactivates voxels. The 3D mesh underneath would slowly contract and become smaller. And at every increment in which it no longer takes up 50% of the previous voxel, that row of voxels would disappear to be replaced by one that is closer to the center of that mesh.

And another feature of this process and that is important to the editing process is that it is not just removing voxels, but also adding voxels. And this process works similarly. Therefore, if a user wanted to add more voxels where they had previously been removed, a user could switch to a tool that adds volume to the 3D mesh. This action would be similar to how the voxels were removed when they were no longer desired to be part of the 3D voxelized mesh. When 50% or whatever percentage of filled voxels are determined or set by the rendering engine to no longer be included within their interior of our 3D object, they will then reappear or be turned back on, become visible when 50% is again, reconstituted in the 3D mesh itself. Furthermore, because there is a slightly delayed appearance of the voxel being removed due to the fact that a 3D mesh is moving slowly in space on a fine resolution, and the voxels are turning on and off based on a binary calculation.

In one preferred arrangement, during such a user-initiated modification, the rendering engine could produce some type of user feedback. This is similar to how in some online or virtual games, the systems generate visual and or audio user feedback as a user mines through a block of granite, for example. The block of granite slowly shows that it is disintegrating while the voxel is not entirely removed, but rather small chunks of the voxel are illustrated as splitting or falling off a remainder voxel so as to graphically illustrate that it is the block a user is slowly and methodically removing. When implementing the presently disclosed rendering engine, if a user is smoothing away blocks as if they were clay, there is an opportunity to add a user feedback that displays on the affected blocks in a similar way in which particles are removed from the underlying voxels. In one arrangement, perhaps the underlying voxels change in color, for example, they may fade to yellow or an alternative color. And then when they reach a target color such as a yellow, these small tiny pieces of voxels—voxelettes—disappear, or alternatively they become more transparent. And similarly, the disclosed rendering engine can perform a similar voxel simulation when blocks or voxels are added to the underlying voxelized image.

One mechanism for achieving this user feedback display for voxel removal and addition is to display the condition of the voxel, depending on what percentage of its volume is being occupied by the underlying 3D mesh. As it approaches a default or a user defined threshold (e.g., 50%) at which the voxel will disappear, the condition is displayed increasingly distressed or increasingly transparent. Alternatively, it may be displayed increasingly yellowed or faded to white, blackened. In addition, the methods or systems may also include some audio and/or animated system feedback indicating to the user that a particular voxel is approaching its threshold of being turned off.

And similarly, the rendering engine could use that in the inverse to show that the voxel is becoming more and more stable or rather more and more of its volume is filled by the underlying 3D mesh. Such a user feedback mechanism could be representative of a strength of the voxels based on the underlying 3D mesh.

Because voxelization is calculated on the underlying 3D mesh, that is how the system can determine which voxels to turn on and not turn on. The system can apply the voxelization in real time when there is a change to the underlying mesh. And that means that most techniques for modifying a 3D mesh are viable techniques for editing a voxelized 3D model using the presently disclosed rendering engine.

Normally, however, in a voxel editor, it would be difficult to perform that action because of the uncertainty one would have as a user as to what effect modifications will produce to the voxel appearance. But by editing the 3D mesh underneath, the presently disclosed rendering engine uses similar techniques that exist for 3D modeling and then redrawing the voxelization in real time. Users can see the effect it will have but can also work with the underlying 3D mesh as if it was a normal object. The same would apply for other types of editing tools. Smoothing is one example of an editing tool that can be applied to an underlying 3D mesh in which the user slowly contracts the vertices toward the center of the object.

And by redrawing the voxelized mesh around it upon each frame or each alteration, the presently disclosed rendering engine achieves the effect of being able to slowly smooth a voxelized object. This would normally not be possible because of the binary nature of voxels being turned on or not turned on. And so, the tool set for editing a voxelized model is enhanced through this technique, and more closely mirrors the set of tools that have been developed over a long timeframe and perfected in some cases for working with 3D models.

There are a number of advantages for the user interface and the user experience provided by the disclosed rendering engine. One example of this is that because the underlying mesh is maintained, the presently disclosed rendering engine allows for those same previously mentioned edits in which not one voxel is being turned on or off from a click. But an underlying 3D mesh is being shaped and morphed organically similar to how a sculptor would mold clay. Through inputs, such as using a single finger or multi-finger swiping back and forth motion or gesture as if the user is rubbing away a surface or pulling to expand or rubbing to add volume as if the user were applying it from the tip of the user's finger. These are more intuitive motions, and so with certain voxel editors, if you want to add volume, you either have to draw a geometric shape and then chip away at it individually, or with planned geometric motions, such as subtracting one angle from one side, and then going in and editing the original shape from another side in the hopes of creating the desired modified geometrical shape.

But with the presently disclosed rendering engine, a user is able to affect multiple voxels at once, meaning that faster workflows can be created, which also requires less effort, or even with editing experience, can resemble complex natural objects in the world.

In one preferred arrangement, the user interface comprises two inputs or two settings, rather than a whole list of complex editing tools. In one preferred arrangement, these inputs comprise detented sliders. Such detented sliders may be presented to the user by way of a display or a touch sensitive interface of a computing device, such as the computing devices illustrated in FIGS. 1 and 2.

This means that the detented sliders may be set at zero and are electronically calibrated so that slider movement affects a single pixel, which then has the effect on the 3D mesh of removing or adding a volume on a 3D mesh. That would constitute the addition or removal of that voxel that has been affected by the user. But if the slider is turned to a second position, like moving the slider up to a setting past zero, then a user no longer affects single voxels. The user now has the ability to smooth, as if it were a more organic modeling substance like clay and therefore can affect a plurality of voxels during a single movement of the slider.

And so, therefore, with simply a switch between a negative and positive, meaning voxels will be added or subtracted. And then if it is a single voxel or many voxels, the biggest could be that a user can reduce down the whole model with a single brush stroke. A user is then able to include the functionality of many professional modeling tools found in some types of 3D modeling software used by professionals, as well as the simplicity of voxel editors that more novice users may be familiar with using or feel more comfortable using. That is one of the advantages of the presently disclosed rending engine in that it achieves a balance in technological accessibility between these two types of editing tools.

In one preferred arrangement, the disclosed user interface consists of any number of tools that might be appropriate for particular use case or for a particular scenario. And the reason why these tools are then more suitable is because they allow for more granular modification of voxels, which are binary. For example, user motions may be utilized so as to reduce an edge that may result in the final desired appearance. Whereas editing voxels directly would require precision tapping of only the voxels that a user would want to remove in order to soften the curvature of an edge or round off a corner. And so, because the disclosed rendering engine is modifying the underlying 3D mesh, which is then being re-voxelized or redrawn in voxels, the presently disclosed systems and methods present the opportunity to create novel types of tools and editing methods that provide a more organic or more natural feel to the different computing platforms in which the interface would be present such as a touch sensitive interface of a computing device, such as a mobile device. (See, e.g., FIGS. 1 and 2).

An example of this opportunity of an interface for switching between add and subtract would be for a user to select the add tool and then pick the subtract tool. On a mobile device for faster interaction, in one preferred arrangement, the disclosed rendering engine can detect that the user has decided to switch between adding and subtracting by the number of fingers that they were rubbing over the touch sensitive interface or just a portion of the touch sensitive interface. For example, in one arrangement, if the user rubs with one finger, the rendering engine will recognize this input as a request to remove voxels. Alternatively, if the user rubs with two fingers, the rendering engine will recognize this input as a request to add voxels. Alternative configurations are also a possibility.

For every plane in a three-dimensional object, a material can be assigned. And the material definition, as standard in the industry, is a definition of color and material reflectivity, and a level of transparency. Texture can also be included. Therefore, a two-dimensional graphic file can be mapped over a plane, allowing for things like zebra stripes or polka dots, or any graphic that a user would like to display. And so, since these standards exist for defining materials, it is now required to consider how the rendering engine can handle the use of materials with regard to voxels. These voxels are cubic representations in three-dimensional space, and which are generally intended to have a single material applied to them. For example, in one arrangement, the system may allocate one material per voxel at a time. However, those of ordinary skill in the art will recognize, alternative allocation scenarios may also be used.

In one arrangement, the planes of that 3D mesh that are contained within the voxel will comprise a material assignment. Similar to how the rendering engine measures the volume of the voxel that is being occupied by underlying mesh, the rendering engine evaluates the percentage of materials that occupy the voxel. Therefore, the rendering engine could use this evaluation step to determine what may be referred to as a dominant material. And therefore, in one preferred arrangement, the dominant material could then be used to cover the planes and faces of the voxel.

For example, in one arrangement, the rendering engine may determine that 65% of the underlying 3D mesh is material referred to as an aluminum metal, that is silver in appearance and reflective and opaque. And then the remaining 35% of the 3D mesh inside the voxel space is a material referred to as glass, which is transparent and also reflective and largely uncolored. In one arrangement, the rendering engine may then decide that the voxel will display the material as aluminum because it has been determined to be the dominant material in the particular voxelized area or space. In an alternative arrangement, the rendering engine could use a ratio and determine that the planes of the underlying 3D mesh on one side of the voxel, the 35% represented in glass, might justify one face of the voxel.

The face closest to those planes made of glass that may be suitable to display using glass and the remainder displayed using aluminum. Again, this is one preferred method of assigning materials to the faces of a voxel. An alternative material assignment arrangement might include the rendering engine changing the material of the entire voxel once the engine computes and determines a particular threshold of the underlying material.

There are the other material assignment possibilities to manipulate the faces and the materials as well. One consideration is that transparency in voxels introduces some complexity, because while voxels represent the general surface area of the underlying 3D mesh, voxels comprise right angles and comprise generally rigid geometries. And assigning transparent materials to voxels may result in unexpected views of right angles toward the inside of the 3D object, which may be different than a smooth appearance of a 3D object made of a transparent material, as may be generated during common 3D rendering systems.

But this however may also lead to the presently disclosed rendering engine and systems to generate novel appearances that are beneficial. As the presently disclosed rendering is quite flexible in its approach to object creation and editing, users of the presently disclosed systems and methods will be able to experiment with the appearance of transparent materials on a voxelized model, and to understand what design aesthetic they prefer.

And the rendering engine has the ability to mix and match and produce voxels that have novel appearances based on what the engine detects as underneath these voxels. The disclosed systems and methods enable specific voxels or a plurality of adjacent voxels to be colored or materials assigned by the creative juices or desires of a user such that the voxel is given a different appearance than the underlying 3D mesh. This may be the case where the user chooses or decides that a particular voxel should stand out, for example, as a red nose on the end of a particular reindeer. Whereas the underlying 3D mesh had only a black nose and the user can color that voxel independently. And user and/or the rendering engine may choose to assign the new material to the underlying 3D mesh or leave material assignment of voxels separate from material assignment of the underlying 3D mesh.

In one preferred arrangement, the presently disclosed rendering engine will utilize an algorithm that decides at what point a color is favored over another color. In addition, the rendering engine can also decide on how the systems and methods will handle stretching and contracting of surface areas in relation to displayed color per voxel.

Potential use algorithms will be based on modifying or amending certain algorithms that are used for reducing or enlarging digital images. In one arrangement, a nearest neighbor calculation can be used to determine that a threshold of color four out of five pixels, four out of five voxels that are used to represent the space that is now occupied by two voxels. In one example, four out of those five voxels are white and one was black. Therefore, the rendering engine color algorithm may now determine that of the two voxels, that the system has not reached a particular target color ratio (e.g., a 50/50 ratio) of white to black, and therefore the rendering engine determines that both voxels shall be white. Of course, those of ordinary skill in the art will recognize, that this particular target color ratio can be revised or amended so as to produce different coloration determination results.

In an alternative configuration, the disclosed rendering engine performs a recalculation of color once the 3D mesh contraction or expansion has occurred during an editing step. In such a scenario, the rendering engine may determine that an optimal color or a desired object coloration may be generated where the color of the voxel or voxels that reside adjacent to the targeted voxel in question shall be as the chosen colorization. Rather than its own unique color, in certain arrangements, this may result in some detail being lost as the user makes edits. However, the disclosed systems and methods may comprise a default operation where the resulting voxel colorization generates what the user would intend and then the user will be enabled to provide additional edit work to restore some fine detail of color, if that is what the user desires.

FIGS. 14 a, b, c illustrate a system for editing a 3D voxelized object. More specifically, FIGS. 14 a, b, c illustrate a system for symmetrically editing a 3D voxelized object.

In this illustrated arrangement, FIGS. 14 a, b, c illustrate 3D mesh sculpting with a designated axis symmetry enabled. Enablement may occur by way of a default within the rendering engine or may be enabled by the user. In this preferred illustrated example, the X axis symmetry enabled. However, as those of ordinary skill in the art will recognize, alternative symmetrical arrangements may also be utilized. For example, a Y axis symmetry, Z axis symmetry, both X and Y symmetry enabled, and other symmetry arrangements may be utilized as well.

In this editing system, a user enabled feature (here illustrated as an exemplary red circle) is an indication of the size of a user editing tool 1660 that a user can manipulate to affect this 3D object, here a sphere 1600. In one preferred arrangement, such a user tool may be activated by a user manipulating certain features on a computing device, such as a handheld computing device (e.g., computing units illustrated in FIGS. 1 and 2). In this particular arrangement, the editing features may be enabled where a user holds down either a single finger or multiple fingers and these fingers are then moved along the surface of the computing device display or touch sensitive interface (see FIG. 2), creating a swiping gesture. The rendering engine than translates the user's finger movement and then manipulates the movement of the editing tool 1660. Here, this editing tool 1660 is graphically represented as a circle. However, as those of ordinary skill in the art will recognize, alternative editing tool configurations may also be utilized.

As illustrated, the user is moving this editing tool 1660 around the 3D object 1600 and the object changes its shape symmetrically as illustrated in FIG. 14b. And so, as a user swipes the editing tool 1660 over the 3D voxelized image 1600, the longer that user swipes over this object, the more voxels become un-selected or are turned off or removed from this object. And the un-selection process occurs symmetrically about the X axis. As a consequence of the user's movement of the editing tool 1660, and as illustrated in FIG. 14c, the voxelized image 1600 is deformed along its right side equally along its left side. Therefore, the object is symmetrically edited along the object's X-axis.

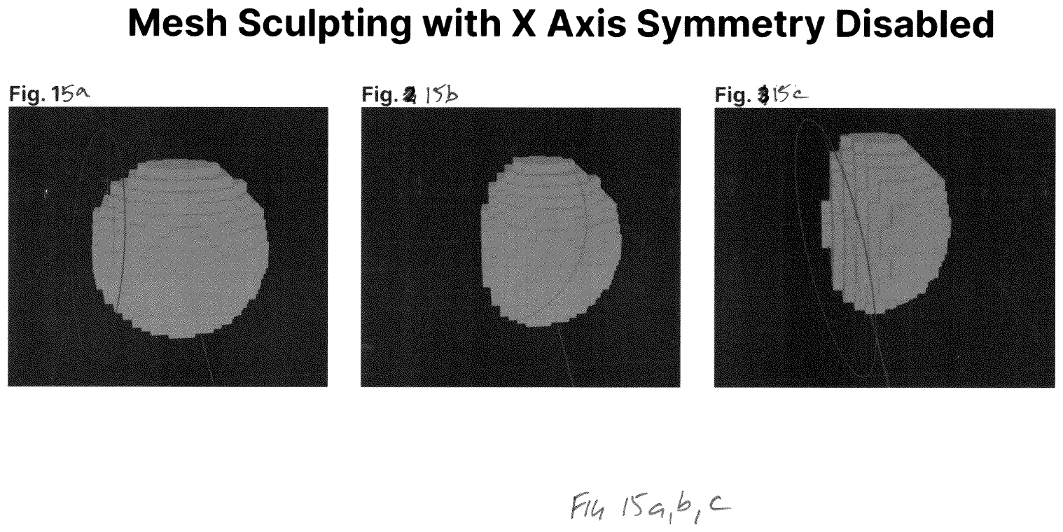

FIGS. 15 a, b, c illustrate an alternative system for editing a 3D voxelized object. More specifically, FIGS. 15 a, b, c illustrate a system for non-symmetrically editing a 3D voxelized object.

In this particular arrangement, similar to the system illustrated in FIGS. 14 a, b, c, as a user is holds down either a single finger or multiple fingers and these fingers are then moved along the surface of the computing device display. The rendering engine than translates the user's finger movement and then manipulates the movement of an editing tool. Here, this editing tool is represented as a circle 1660. However, as those of ordinary skill in the art will recognize, alternative editing tool configurations may also be utilized.

As illustrated, the user is moving this editing tool 1660 around and about the voxelized image 1600. And so, as a user swipes the editing tool 1660 over the 3D voxelized image, the longer that a user swipes over this object, the more voxels that will be un-selected or are turned off or removed from this object. And the un-selection process occurs non-symmetrically about the object's X-axis. As a consequence of the user's movement of the editing tool, the voxelized image 1600 is deformed on the left side of the image but is not deformed along the right side of the image. Therefore, the object is non-symmetrically edited along the object's X-axis.

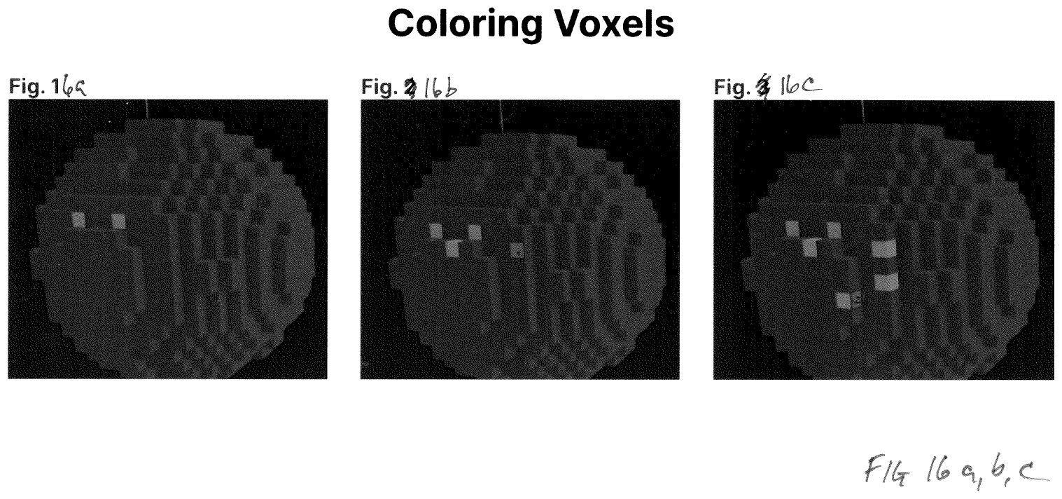

FIGS. 16 a, b, c illustrate an alternative system for coloring a 3D voxelized object 1600. As illustrated, this is how a user can color individual voxels of the voxelized image. More specifically, a user can use an editing tool to first select a color from a color tablet and then the user can select a specific voxel to vary or change the color of the individual voxel.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

We claim:

1. A method of creating a modifiable digital representation, the method comprising the steps of:
identifying at least one three-dimensional mesh;
creating a metadata file comprising at least one separate object file,
the at least one separate object file based in part on the at least one three-dimensional mesh;
generating a pre-rendering version of the at least one three-dimensional mesh;
preparing the pre-rendering version of the at least one three-dimensional mesh for rendering; and
performing a render of the pre-rendering version of the three-dimensional mesh.

2. The method of claim 1, wherein
the step of generating the pre-rendering version of the at least one three-dimensional mesh comprises the step of
generating a blockified version of the at least one three-dimensional mesh.

3. The method of claim 2, wherein
the step of generating the blockified version of the at least one three-dimensional mesh comprises generating a voxelized version of the at least one three-dimensional mesh.

4. The method of claim 1, further comprising the step of:
processing the pre-rendering version of at least one three-dimensional mesh so that the pre-rendering version is viewable on a computing device.

5. The method of claim 4, wherein:
the computing device comprises a handheld computing device.

6. The method of claim 1, further comprising the step of
selecting an image format for the at least one three-dimensional mesh.

7. The method of claim 6, wherein
the image format for the three-dimensional mesh comprises an .OBJ format.

8. The method of claim 1, further comprising the step of
performing complex three-dimensional object file edits.

9. The method of claim 1, wherein the step of generating the pre-rendering version of the at least one three-dimensional mesh comprises the step of defining at least one pre-rendering parameter.

10. The method of claim 9,
wherein the at least one pre-rendering parameter comprises an occupation parameter,
wherein the occupation parameter is utilized to define a voxelized mesh.

11. The method of claim 1, further comprising the step of
defining a set of parameters for the at least one separate object file,

12. The method of claim 11,
wherein the set of parameters comprises at least one parameter selected from a group of transparency level, color, reflectivity, and texture.

13. The method of claim 1, further comprising the step of
defining a plurality of data keys for the at least one separate object file,
wherein each of the plurality of data keys is representative of a predefined data type.

14. The method of claim 1, wherein the step of creating a metadata file comprises the step of:
selecting a serialization language.

15. The method of claim 14, wherein the serialization language is selected from a group consisting of XML, JSON, and YAML.

16. The method of claim 1, wherein the step of creating the metadata file comprises the step of:
generating a plurality of descriptors.

17. The method of claim 1, wherein the step of creating the metadata file comprises the step of:
defining at least one attach point for at least one sub-object residing in the metadata file,
the attach point defining where the at least one sub-object may be attached to a second sub-object.

18. The method of claim 17, wherein the at least one attach point comprises a vertex that comprises X, Y, and Z coordinates.

19. The method of claim 1, wherein the step of creating the metadata file comprises the step of:
defining at least one interaction point comprising X, Y, and Z coordinates.

20. The method of claim 19, wherein
the at least one interaction point is labeled for purposes of performing automated interactions or automated animations.

21. The method of claim 1, wherein
the modifiable digital representation comprises an avatar for use in a virtual universe.
